(19) United States
(12) Patent Application Publication
(10) Pub. No.: US 2004/0199303 A1
(43) Pub. Date: Oct. 7, 2004

(54) Rental vehicle system, in-vehicle computer system, digital camera system and digital camera

(75) Inventors: Akira Ohmura, Shibuya-ku (JP); Masahide Tanaka, Kawasaki-shi (JP); Masahiro Juen, Kanazawa-ku (JP)

Correspondence Address: OLIFF & BERRIDGE, PLC, P.O. BOX 19928, ALEXANDRIA, VA, 22320, US

(73) Assignees: NIKON CORPORATION, Tokyo (JP); NIKON TECHNOLOGIES INC., Tokyo (JP)

(21) Appl. No.: 10/805,445

(22) Filed: Mar. 22, 2004

(30) Foreign Application Priority Data
Apr. 1, 2003 (JP) 2003-098231
Apr. 1, 2003 (JP) 2003-098229
Apr. 1, 2003 (JP) 2003-098230
Apr. 1, 2003 (JP) 2003-098232
Apr. 1, 2003 (JP) 2003-098233

(51) Int. Cl. G06F 17/00; G06F 19/00

(52) U.S. Cl. 701/5

(57) ABSTRACT

This invention provides an in-vehicle computer system that makes it easy to handle an image data taken with a digital camera in a vehicle and the like. For example, a print order of an image data can be placed from a vehicle and a print can be picked up at a vehicle stopover location when the vehicle stops over. The vehicle is navigated toward a location where to be able to pick up the print. In a case of a rental vehicle, a print can be picked up when returning the vehicle. Furthermore, handling an image data in a vehicle is configured to have no effect on a safety drive. For example, when an in-vehicle computer communicates with an external computer, data necessary to drive a vehicle is delivered in preference to an image data. An operation to connect a digital camera and an in-vehicle computer is made easy. But, an operation of handling an image data at the wheel is configured to be impossible.

### INCORPOLATION BY REFERENCE

This application is based upon and claims priority of Japanese Patent Applications No. 03-98229, 03-98230, 03-98231, 03-98232 and 03-98233 filed on Apr. 1, 2003, the contents being incorporated herein by reference.

### BACKGROUND OF THE INVENTION

1. Field of the Invention

This invention relates to an in-vehicle computer system and, particularly, an in-vehicle computer system in which handling an image data and, more particularly, a system working along with an in-vehicle computer and a digital camera. Moreover, this invention relates to a digital camera transmitting a taken image to an external apparatus.

2. Description of Related Art

A system in which a computer is installed in a vehicle and implements various functions such as the Internet connection, car navigation, security and so has been developed. Then, just about everything can be realized in a vehicle too like a computer at a home can do. As a result, it is expected that a frequency of in-vehicle dealing with an image data taken with a digital camera will be increased. Such a system in which an image data is dealt with in a vehicle can be installed in a rental car. A trip is cited as one of reasons for renting a car. It is likely that some of customers who rent a car for going on a trip have used a digital camera to record a memory of a trip. Further, there is a digital camera system in which an image data taken with a camera cell phone is transmitted to a server computer over a wireless and the server computer corrects and optimizes the image data. Furthermore, a digital camera has been proposed, wherein the digital camera with communication abilities transmits an image data taken with the digital camera to an external server computer etc, not to the camera internal memory and stores the image data in a memory of the external computer. In such the system, only by providing a minimum capacity memory, a lot of picture takings can be accomplished with no care about a memory capacity

### SUMMARY OF THE INVENTION

Thus, even in a vehicle, it is necessary to boost ease of use on an image data taken with a digital camera. In a rental vehicle, an in-vehicle computer is just for temporal use only, so we must be careful when storing an image data therein. For example, something has to be done to prevent data from being viewed by other rental car user. Also, at a time of handling an image data while driving, we should attend safety driving.

An object of this invention is to provide a system in which handling an image data taken with a digital camera in a driven vehicle can be made easier.

As a data volume of an image data used in a camera phone has been small, there is no problem about traffic. An image data taken with a camera phone is processed by such an image processing as compression and the like with camera's own abilities, so an image quality cannot be enhanced even if the image data is optimized once again. This invention provides a system such that stable communication traffic is ensured even when an image data becomes large. If a digital camera with communication abilities transmits an image data right after the image data is taken, a turkey of an image data is also transmitted. Then, as a delete signal is required to be sent in order to delete the turkey, a communication cost can be increased. And further, sending a delete signal can be attributable to overcrowding communication traffic. It is an object of this invention to provide a digital camera that can refrain from transmitting a wasteful image as much as possible.

In order to achieve the object, according to claim 1 set forth in this invention, there is provided a vehicle driving management system which includes an order taking that takes a print order of an image data, a stopover information obtaining device that obtains stopover information including a vehicle's stopover depot or stopover time, a printer that prints an image data and a control device that controls so as to be able to hand over merchandise printed by the printer at a stopover depot or a stopover time obtained by the stopover information obtaining device. Accordingly, a vehicle user can pick up a print on print order at such a stopover depot earlier than before in the prior art and labor to obtain a print can be drastically saved too.

According to claim 2 set forth in this invention, there is provided a rental vehicle system which includes an order taking device that takes a print order of an image data, a return depot obtaining device that obtains a return depot of a rental vehicle, a printer that prints an image data and a control device that controls so as to be able to hand over merchandise printed by the printer at a return depot obtained by the return depot obtaining device. Accordingly, a rental vehicle user can pick up a print on print order at such a stopover depot and labor of a rental vehicle user can be drastically saved too.

According to claim 3 set forth in this invention, there is provided the rental vehicle system disclosed in claim 2, wherein the control device is provided with an arrangement device that arranges delivery.

According to claim 4 set forth in this invention, there is provided the rental vehicle system disclosed in claim 2, wherein the control device instructs a printer provided at the return depot to make a print.

According to claim 5 in this invention, there is provided a rental vehicle system which includes an order taking device that takes a print order of an image, a return time obtaining device that obtains a return time of a rental vehicle, a printer that prints an image data and a control device that controls so as to be able to hand over merchandise printed by the printer at a return time obtained by the return time obtaining device. Accordingly, a rental vehicle user can pick up a print at the same time when retuning a rental vehicle, so there is no wasteful time to spend.

According to claim 6 set forth in this invention, there is provided the rental vehicle system disclosed in claim 5, wherein the control device controls a print start time of the printer.

According to claim 7 in this invention, there is provided a vehicle driving management system which includes a communication device that communicates with an external computer, an ordering device that places a print order of an image data with the external computer via the communication device, a stopover information obtaining device that obtains stopover information including a vehicle's stopover depot or stopover time, a detection device that detects a present positioning or a present time of the vehicle and a control device that controls so as to prompt to place a last print order via the ordering device before the vehicle arrives at the stopover depot or the stopover time comes based upon the present positioning or the present time detected by the detection device. Accordingly, a risk that a vehicle user might forget to order a print can be reduced since the vehicle user can pick up a print on print order at any of stopover depots.

According to claim 8 in this invention, there is provided a rental vehicle system which includes a communication device that communicates with an external computer, an ordering device that places a print order of an image data with the external computer via the communication device and a control device that controls so as to prompt to place a last print order via the ordering device prior to returning of a rental vehicle. Accordingly, a rental vehicle user can alleviate the problem that a print order is forgotten.

According to claim 9 in this invention, there is provided the rental vehicle system disclosed in claim 8 which further includes a detection device that detects whether the rental vehicle comes within a given distance inclusive of a return depot, wherein the control device prompts to place the last print order based upon a detection result of the detection device. Accordingly, a rental vehicle user can alleviate a problem that placing an additional print order is needed at a final stage and avoid a non-necessary print that would be a garbage item.

According to claim 10, there is provided with a rental vehicle system which includes an ordering device that places a print order of an image data, a settlement instruction device that instructs to settle a print charge ordered by the ordering device; and a control device that controls so as to instruct a settlement of a print charge by the settlement instruction device prior to returning of a rental vehicle. Accordingly, there are no hassles about a settlement at returning a rental vehicle or after returning the vehicle.

According to claim 11 in this invention, there is provided the rental vehicle system disclosed in claim 10, wherein the control device controls so as to instruct a settlement of a rental vehicle charge along with a settlement of the print charge.

According to claim 12 in this invention, there is provided a rental vehicle system which includes a memory that is provided in a vehicle and stores an image data received from a digital camera, a backup device that backs up so as to be able to view an image data in the memory even after a rental vehicle is returned and a control device that controls so as to back up an image data in the memory before the rental vehicle is returned. Accordingly, a rental vehicle user can view an image data after returning a rental vehicle.

According to claim 13 in this invention, there is provided the rental vehicle system disclosed in claim 12 which further includes a communication device that communicates with an external computer, wherein the backup device transmits an image data to the external computer via the communication device.

According to claim 14 in this invention, there is provided the rental vehicle system disclosed in claim 12 which further includes a storage device that stores data in a portable memory, wherein the backup device stores an image data of the memory in a portable memory.

According to claim 15 in this invention, there is provided the rental vehicle system disclosed in claim 12, wherein the control device prompts a user to back up an image data in the memory.

According to claim 16 in this invention, there is provided the rental vehicle system disclosed in claim 12 which further includes a detection device that detects whether a rental vehicle comes within a given distance inclusive of a return depot, wherein the control device controls so as to back up an image data corresponding to a detection result of the detection device.

According to claim 17 in this invention, there is provided the rental vehicle system disclosed in claim 12, wherein the control device controls so as to be able to back up by the backup device corresponding to settlement completion of a rental vehicle charge or a rental vehicle charge and a print charge. Accordingly, a settlement of a charge can be surely ensured.

According to claim 18 in this invention, there is provided a rental vehicle system which includes a memory that is provided in a rental vehicle and stores an image data received from a digital camera, an erasing device that erases an image data in the memory and a control device that controls the erasing device so as to erase an image data in the memory automatically prior to returning of the rental vehicle. Accordingly, there is no need for a rental vehicle user to perform an operation to erase an image data by him/herself. A reduction in a memory capacity can be avoided and an unauthorized use of an image data by other user can be prevented.

According to claim 19 in this invention, there is provided the rental vehicle system disclosed in claim 18 which further includes a detection device that detects whether a rental vehicle comes to a return location within a given distance, wherein the control device controls so as to erase an image data automatically corresponding to a detection result of the detection device.

According to claim 20 in this invention, there is a camera system which includes an in-vehicle computer that is installed in a vehicle and executes a given function, a digital camera that takes a photograph of a subject, a connecting device that connects the in-vehicle computer and the digital camera, a communication device that enables a data to be sent/received between the in-vehicle computer and an external computer, an instructing device that instructs to transmit to the external computer an image data taken with the digital camera via the communication device, a judging device that judges an existence or a non-existence of a data to be sent/received to realize the given function being executed by the in-vehicle computer and a control device that controls so as to transmit a data to be sent/received by the given function in preference to transmission of an image data by the instructing device based upon judgment of the judging device. Accordingly, transmission of an image data does not have a bad effect on realization of a given function being implemented by an in-vehicle computer.

According to claim 21 in this invention, there is provided the camera system disclosed in claim 20, wherein the given function is car navigation abilities.

According to claim 22 in this invention, there is provided the camera system disclosed in claim 20, wherein the control device sends/receives data necessary to realize the given function prior to starting transmission of the image data to the external computer.

According to claim 23 in this invention, there is provided the camera system disclosed in claim 20, wherein the judging device executes judgment while the image data is in transit and the control device suspends transmission of the image data when it is judged that there is data to be sent/received by the given function while the image data is in transit.

According to claim 24 in this invention, there is provided the camera system disclosed in claim 20, wherein the external computer is a print server computer and the image data is transmitted in order to make a print.

According to claim 25 in this invention, there is provided the camera system disclosed in claim 20, wherein the external computer is an image processing computer that is provided with image processing abilities and the image data is transmitted to perform an image processing.

According to claim 26 in this invention, there is provided the camera system disclosed in claim 25, wherein the image data is a RAW image data and the image processing is a pixel interpolation processing.

According to claim 27 in this invention, there is provided the camera system disclosed in claim 25, wherein the communication device transmits information about the digital camera along with the image data and the image processing is a processing that optimizes an image based upon information about the digital camera.

According to claim 28 in this invention, there is provided the camera system disclosed in claim 22, wherein the connecting device is a cradle in which the digital camera is arranged.

According to claim 29 in this invention, there is provided a camera system which includes an in-vehicle computer that is installed in a vehicle, a digital camera that takes a photograph of a subject, a connecting device that connects the in-vehicle computer and the digital camera, a communication device that enables data to be sent/received between the in-vehicle computer and an external computer, an instructing device that instructs so as to transmit to the external computer an image data taken with the digital camera via the communication device and a control device that controls so as to put the image data on standby for transmission until the communication device becomes communicable with the external computer in a case where the communication device cannot communicate with the external computer when transmission of an image data is instructed by the instructing device. Accordingly, when transmission of an image data is not communicable with an external computer, there is no need to re-set for transmission since an image data is caused to be on standby for transmission.

According to claim 30 in this invention, there is provided the camera system disclosed in claim 29, wherein the control device automatically starts transmission of an image data on standby for transmission when the communication device becomes communicable with an external computer.

According to claim 31 in this invention, there is provided a camera system which includes an in-vehicle computer that is installed in a vehicle, a first communication device, a digital camera that takes a photograph of a subject, a connecting device that connects the in-vehicle computer and the digital camera, a second communication device that enables data to be sent/received between the in-vehicle computer and the external computer and an instructing device that instructs so as to transmit to the external computer an image data taken with the digital camera via the communication device, wherein the in-vehicle computer with connection to the digital camera by the connecting device enables data to be sent/received between the in-vehicle computer and the external computer via the first communication device and the instructing device uses the second communication device in preference to the first communication device.

Further, according to claim 32 in this invention, there is provided the camera system disclosed in claim 31, wherein the in-vehicle computer is provided with an image processing device that image-processes an image data and, when the second communication device is communicable, transmits an image data using the second communication device, not performing the image processing on an image data.

According to claim 33 in this invention, there is provided the camera system disclosed in claim 32, wherein, when the first communication device is communicable whereas the second communication device is not communicable, an image data is performed by the image processing and is transmitted using the first communication device.

According to claim 34 in this invention, there is provided the camera system disclosed in claim 32, wherein, the image data is a RAW image data and the image processing is any of a pixel interpolation processing, an image optimizing processing or an image compression processing.

According to claim 35 in this invention, there is provided an in-vehicle computer which includes a navigation apparatus that realizes car navigation abilities, a display monitor that performs a navigation display of the car navigation abilities, an obtaining device that obtains transmittable area information on a wireless communication and a control device that controls so as to display a transmittable area on a navigation display of the display monitor based upon the obtained transmittable area information.

According to claim 36 in this invention, there is provided the in-vehicle computer disclosed in claim 35 which further includes a communication device that communicates with an external computer and a memory that stores data to be transmitted via the communication device, wherein, when data to be transmitted is stored in the memory, a transmittable area is automatically displayed on a navigation display.

According to claim 37 in this invention, there is provided the in-vehicle computer disclosed in claim 35, wherein the navigation apparatus calculates a driving route of car navigation using the transmittable area information.

According to claim 38 in this invention, there is provided the in-vehicle computer disclosed in claim 37 which further includes a communication device that communicates with an external computer and a memory that stores data to be transmitted via the communication device, wherein, when data to be transmitted is stored in the memory, the navigation apparatus calculates a driving route of car navigation using the transmittable area information.

According to claim 39 in this invention, there is an in-vehicle computer system which includes an in-vehicle computer that is installed in a vehicle, a portable terminal that stores data, a connecting device that connects the in-vehicle computer and the portable terminal, a communication device that enables data to be sent/received between the in-vehicle computer and an external computer, an instructing device that instructs so as to transmit to the external computer an image data in the portable terminal via the communication device, a judging device that judges whether there is data to be sent/received in order to realize other function being executed by the in-vehicle computer and a control device that controls so as to transmit data to be sent/received by the other function in preference to transmission of data in the portable terminal by the instructing device.

According to claim 40 in this invention, there is provided an in-vehicle computer system which includes an in-vehicle computer that is installed in a vehicle, a portable terminal that stores data, a connecting device that connects the in-vehicle computer and the portable terminal, a communication device that enables data to be sent/received between the in-vehicle computer and an external computer, an instructing device that instructs so as to transmit to the external computer an image data in the portable terminal via the communication device and a control device that controls so as to put data in the portable terminal on standby for transmission until the communication device becomes communicable with the external computer in a case where the communication device cannot communicate with the external computer when transmission of data in the portable terminal is instructed by the instructing device.

According to claim 41 in this invention, there is provided an in-vehicle computer system which includes a navigating device that navigates a driving route, a driving route setting device that sets a driving route for a destination and a print control device that controls so as to perform a print processing on an image data by a given printer corresponding to the driving route set by the driving route setting device.

According to claim 42 in this invention, there is provided the in-vehicle computer system disclosed in claim 41, wherein the print control device controls so as to perform a print processing by a printer at a print laboratory located along just about a driving route.

According to claim 43 in this invention, there is provided the in-vehicle computer system disclosed in claim 41, wherein the print control device controls so as to enable a print to be picked up at a hand-over station along just about a driving route.

According to claim 44 in this invention, there is provided the in-vehicle computer system disclosed in claim 41 which further includes a communication device that communicates with an external computer, wherein the print control device instructs to the external computer a print processing.

According to claim 45 in this invention, there is provided the in-vehicle computer system disclosed in claim 41 which further includes a communication device that communicates with an external computer, wherein the print control device controls so as to receive information on a print from the external computer via the communication device.

According to claim 46 in this invention, there is provided the in-vehicle computer disclosed in claim 45, wherein the print control device receives print laboratory information from the external computer via the communication device.

According to claim 47 in this invention, there is provided the in-vehicle computer system disclosed in claim 45, wherein the print control device receives print hand-over station information from the external computer via the communication device.

According to claim 48 in this invention, there is provided the in-vehicle computer system disclosed in claim 45, wherein the print control device transmits geographic positioning information to the external computer and receives information on a print.

According to claim 49 in this invention, there is provided the in-vehicle computer system disclosed in claim 43, wherein the hand-over station is a gas station.

According to claim 50 in this invention, there is provided the in-vehicle computer system disclosed in claim 41, wherein the in-vehicle computer is installed in a rental vehicle.

According to claim 51 in this invention, there is provided the in-vehicle computer system disclosed in claim 50, wherein the print control device controls so as to be able to pick up at a hand-over station closer to the return location of a rental vehicle.

According to claim 52 in this invention, there is provide a camera system which includes a digital camera that takes a photograph of a subject and captures an image data, a plurality of image processing computers that receive an image data taken with the digital camera and perform an image processing with respect to the received image data and a certificate computer that certificates a user who transmits an image data to be received by the image processing computer, wherein the certificate computer is provided with a selecting device that selects an image processing computer performing an image processing on an image data taken with the digital camera. Accordingly, a certified image data is received by a plurality of image processing computers and performed by an image processing, so overcrowding of communication traffic can be reduced and load accrued from an image processing can also be alleviated.

According to claim 53 in this invention, there is provided the camera system disclosed in claim 52, wherein, when certification of the user is succeeded, the certificate computer permits the user to access the image processing computer.

According to claim 54 in this invention, there is provided the camera system disclosed in claim 52, wherein, when certification of the user is succeeded, the certificate computer transmits connection address information on the image processing computer to the user.

According to claim 55 in this invention, there is provided the camera system disclosed in claim 52, wherein the certificate computer does not receive an image data taken with the digital camera.

According to claim 56 in this invention, there is provided the camera system disclosed in claim 52 which further includes an in-vehicle computer having a communication device that transmits an image data taken with the digital camera to an external computer, wherein the in-vehicle computer transmits the image data to the image processing computer.

According to claim 57 in this invention, there is provided the camera system disclosed in claim 52 which further includes communication abilities, wherein the certificate computer is provided with a receiving device that receives certificate information from the digital camera, a certificating device that certificates the user based upon certificate information received by the receiving device and a transmitting device that transmits to the digital camera a connection address in order to access the image processing computer when certification is succeeded by the certificating device.

According to claim 58 in this invention, there is provided the camera system disclosed in claim 52, wherein the image processing computer is a computer that instructs a printer to print an image data.

According to claim 59 in this invention, there is provided the camera system disclosed in claim 52, wherein the image processing computer is a plurality of computers executing a print processing that are provided at a print laboratory.

According to claim 60 in this invention, there is provided the camera system disclosed in claim 52, wherein the digital camera transmits to the image processing computer a taken image data in a RAW image data format and the image processing computer executes an image processing that imagines the RAW image data.

According to claim 61 in this invention, there is provided the camera system disclosed in claim 52, wherein the digital camera transmits to the image processing computer information on a camera and the image processing computer executes an image processing that optimizes an image data taken with the digital camera based upon information on the digital camera.

According to claim 62 in this invention, there is provided a camera system which includes a digital camera that takes a photograph of a subject by an operation of a user, a plurality of image processing computers that receive an image data taken with the digital camera and perform a image processing with respect to an received image data and an image storage computer that stores an image data processed by the image processing with a plurality of image processing computers in an integrated way.

According to claim 63 in this invention, there is provided a camera system which includes a digital camera that takes a photograph of a subject via a taking lens and a plurality of image processing computers that receive a RAW image data taken with the digital camera and information on a camera and perform an image processing with respect to a received image data, wherein the image processing computer is provided with an image optimizing device that performs an optimizing process of eliminating an effect caused by the taking lens with respect to the RAW image data. Accordingly, as an optimizing process of eliminating an effect caused by a taking lens is performed on a received RAW image data, which is almost non-processed, this process is effective.

According to claim 64 in this invention, there is provided the camera system disclosed in claim 63, wherein the information on a camera is information on a product model of the digital camera, the image processing computer stores taking-lens information with linkage to the product model information in advance and the image optimizing device performs the image optimizing process based upon the taking-lens information.

According to claim 65 in this invention, there is provided a camera system which includes a digital camera that takes a photograph of a subject and obtains an image data thereof and a plurality of image processing computers that receive an image data taken with the digital camera and perform an image processing with respect to a received image data, wherein the image processing computer is provided with an updating device that updates an image processing program by accessing a computer storing the latest image processing program automatically prior to executing of the image processing.

According to claim 66 in this invention, there is provided a camera system which includes a digital camera that obtains an image data thereof taking a photograph of a subject, a plurality of image processing computers that receive an image data taken with the digital camera and information on a camera and perform an image processing with respect to a received image data and a computer terminal that performs an optimizing process on an image data taken with the digital camera, wherein, when the image processing computer receives an image data processed by the computer terminal, the image processing computer judges how an optimizing process was performed on an image data and performs an optimizing process alone that was not performed by the computer terminal.

According to claim 67 in this invention, there is provided a camera system which includes an in-vehicle computer that is installed inside a vehicle, a digital camera that is provided with cell phone abilities, a microphone that inputs a voice, and a speaker that outputs a voice, wherein the in-vehicle computer with connection to the digital camera extracts an image data stored in the digital camera and makes it possible to call with the use of the microphone and the speaker.

According to claim 68 in this invention, there is provided the camera system disclosed in claim 67 which further includes a monitor that displays a moving image, wherein the in-vehicle computer makes it possible to perform a TV phone with the use of the monitor, the microphone and the speaker.

According to claim 69 in this invention, there is provided the camera system disclosed in claim 67, wherein the in-vehicle computer is provided with car navigation abilities and the monitor is a monitor that displays a navigation screen.

According to claim 70 in this invention, there is provided the camera system disclosed in claim 67, wherein the camera system is connected to the in-vehicle computer and is provided with a cradle in which the digital camera is arranged and the in-vehicle computer and the digital camera are connected by the cradle.

According to claim 71 in this invention, there is provided a camera system which includes an in-vehicle computer that is installed inside a vehicle, a digital camera that is provided with cell phone abilities, a microphone that inputs a voice; and a speaker that outputs a voice, wherein the in-vehicle computer with connection to the digital camera recharges a battery of the digital camera and makes it possible to call with the use of the microphone and the speaker.

According to 72 in this invention, there is provided a camera system which includes an in-vehicle computer that is installed inside a vehicle and provided with car navigation abilities, a digital camera that is provided with communication abilities and a connecting device that connects the in-vehicle computer and the digital camera, wherein the in-vehicle computer with connection to the digital camera can send/receive data necessary for car navigation using communication abilities of the digital camera. Accordingly, with a simple operation, an image data in a digital camera can be extracted and data necessary for navigation can be also sent/received.

According to claim 73 in this invention, there is provided a camera system which includes a car navigating device that executes car navigation abilities, a monitor that displays a car navigation screen, an extracting device that extracts an image data in a digital camera and a control device that controls so as to display a screen to instruct a print order of an extracted image data on the monitor after an image data was extracted by the extracting device. Accordingly, a print order of an image data can be placed using a monitor of navigation.

According to claim 74 in this invention, there is provided a camera system which includes an in-vehicle computer that is installed inside a vehicle, an extracting device that extracts an image data in a digital camera, an instructing device that instructs an extraction of an image data with the extracting device and a control device that controls so as to stand by an extracting process of an image data in a case where the extracting process of the image data is instructed when a given function is being executed by the in-vehicle computer. Accordingly, an extracting process of an image data does not have any bad effect on a given function an in-vehicle computer is executing.

According to claim 75 in this invention, there is provided the camera system disclosed in claim 74 which further includes a judging device that judges whether or not an extracting process of an image data affects an execution of the given function and a control device that controls so as to halt an extracting process of an image data according to a judgment of the judging device.

According to claim 76 in this invention, there is provided a camera system which includes an in-vehicle computer that is installed inside a vehicle, an extracting device that extracts an image data in a digital camera and a control device that controls so as to suspend the extracting process of an image data in a case where a given function is executed by the in-vehicle computer while an image data is being extracted by the extracting device. Accordingly, an extracting process of an image data does not have any bad effect on a given function to be executed by an in-vehicle computer.

According to claim 77 in this invention, there is provided the camera system disclosed in claim 76 which further includes a judging device that judges whether or not an extracting process of an image data affects an execution of the given function and a control device that controls so as to halt an extracting process of an image data according to a judgment of the judging device.

According to claim 78 in this invention, there is provided an in-vehicle computer which includes a connecting device that connects to a digital camera, an extracting device that extracts an image data from the digital camera and an image processing device that automatically performs an image processing with respect to an image data extracted from the digital camera. Accordingly, labors to perform each image processing on each extracted image data can be saved.

According to claim 79 in this invention, there is provided the in-vehicle computer disclosed in claim 78, wherein the extracting device extracts information on the taking digital camera along with an image data and the image processing device optimizes an image data according to the information.

According to claim 80 in this invention, there is provided the in-vehicle computer disclosed in claim 78, wherein an image data extracted from the digital camera includes a RAW image data and the image processing device performs a pixel interpolation or an image compression with respect to the RAW image data.

According to claim 81 in this invention, there is provided the in-vehicle computer disclosed in claim 78 which further includes a communication device that communicates with an external computer, wherein the communication device transmits to the external computer an image data processed by the image processing device.

According to claim 82 in this invention, there is provide an in-vehicle computer which includes a connecting device that connects to a digital camera, an extracting device that extracts an image data from the digital camera via the connecting device, a judging device that judges whether or not a given condition is met and a control device that controls so as to execute a first process about an image data when it is judged by the judging device that the given condition is met and, when it is judged by the judging device that the given condition is not met, execute a second process about an image data.

According to claim 83 in this invention, there is provided the in-vehicle computer disclosed in claim 82 which further includes a monitor that displays a moving image, wherein the first process displays the extracted image data on the monitor and the second process prohibits the extracted image data from being displayed on the monitor.

According to claim 84 in this invention, there is provided the in-vehicle computer disclosed in claim 83, wherein the control device receives a print order of an image data via the first process.

According to claim 85 in this invention, there is provided the in-vehicle computer disclosed in claim 82 which further includes a detection device that detects a passenger, wherein the judging device judges whether or not there is a passenger by the detection device.

According to claim 86 in this invention, there is provided a digital camera which includes a communication device that transmits a taken image data to an external apparatus and a deleting device that can delete an image data taken at a last time by a specific operation during a certain period of time after an image data was taken, wherein transmission of an image data by the communication device is put on standby during a certain period of time when an image data can be deleted by the deleting device and after the certain period of time has elapsed, the image data is transmitted to an external apparatus. Accordingly, as an image data unnecessary to be stored is not sent out wastefully, an effect on communication costs and communication traffic can be alleviated.

According to claim 87 in this invention, there is provided the digital camera disclosed in claim 86 which further includes a displaying device, wherein the image data taken at a last time is displayed on the displaying device during the certain period of time.

According to claim 88 in this invention, there is provided the digital camera disclosed in claim 87, wherein the displaying device implements a display of prompting a delete operation along with the image data taken at a last time during the certain period of time.

According to claim 89 in this invention, there is provided the digital camera disclosed in claim 86, wherein an image data to be transmitted to an external apparatus by the communication device is a RAW image data.

According to claim 90 in this invention, there is provided an image processing apparatus which includes a communication device that transmits a taken image data to an external apparatus, an image processing device that performs an optimizing process with respect to the image data, an instructing device that instructs an image data to be transmitted to the external apparatus with use of the communication device and a control device that controls so as to perform an optimizing process by the image processing apparatus with respect to an image data instructed to be transmitted to the external apparatus by the instructing device. Accordingly, as an optimizing process is performed on an image data to be transmitted, load becomes small. Also, an image data that has not been performed yet by an optimizing process will be optimized when the image data is transmitted, so a latest optimizing process can be performed.

According to claim 91 in this invention, there is provided the image processing apparatus disclosed in claim 90, wherein the instructing device instructs an image data on print order.

According to claim 92 in this invention, there is provided the image processing apparatus disclosed in claim 90 which further includes an obtaining device that obtains information on a taking camera, wherein the image processing performs an optimizing process with respect to an image data according to the information on a taking camera.

According to claim 93 in this invention, there is provided the image processing apparatus disclosed in claim 90, wherein the image data is a RAW image data.

According to claim 94 in this invention, there is provided an image processing apparatus which includes a communication device that transmits a taken image data to an external apparatus, an image processing device that performs an optimizing process with respect to the image data, an instructing device that instructs an image data to be transmitted to the external apparatus with use of the instruction device and a control device that controls so as to perform an optimizing process with respect to an image data excluding an image data instructed to be transmitted to the external apparatus by the image processing device.

According to claim 95 in this invention, there is provided the image processing apparatus disclosed in claim 94, wherein the external apparatus is provided with a second image processing device that performs an optimizing process with respect to an image data. Accordingly, an image data to be transmitted to an external apparatus is optimized by the external apparatus, whereas an image data not to be transmitted to an external apparatus is optimized by an image processing apparatus. A split processing can be performed.

According to claim 96 in this invention, there is provided an image processing apparatus which includes a receiving device that receives an image data from a digital camera, an image processing device that performs an optimizing process with respect to an image data received by the receiving device and a sending device that automatically transmits to the digital camera an image data performed by an optimizing process with the image processing device. Accordingly, as for a digital camera user, easy of use just like an optimizing process is performed in a digital camera in use can be realized.

According to claim 97 in this invention, there is provided the image processing apparatus disclosed in claim 96 which further includes an obtaining device that obtains information on a taking camera, wherein the optimizing process performs an optimizing process with respect to an image data according to the information on a taking camera.

According to claim 98 in this invention, there is provide the image processing apparatus disclosed in claim 96, wherein the image data is a RAW image data.

According to claim 99 in this invention, there is provided the image processing apparatus disclosed in claim 96 which further includes an identifying device that identifies a file format of a received image data, wherein, when the identifying device detects a RAW image data, an optimizing process is performed after processing of a pixel interpolation.

Other features and advantages according to the invention will be readily understood from the detailed description of the preferred embodiment in conjunction with the accompanying drawings.

### BRIEF DESCRIPTION OF THE DRAWINGS

FIG. 1 is a functional block diagram showing an outline of a camera system of a first embodiment.

FIG. 2 is a block diagram showing a configuration of camera phone 1.

FIG. 3 is a block diagram showing a configuration of certificate server 3.

FIG. 4 is a block diagram showing a configuration of image storage server 4.

FIG. 5 is a block diagram showing a configuration of print server 5.

FIG. 6 is a flow chart showing a control to be executed in CPU 13.

FIG. 7 is a flow chart showing a control to be executed in CPU 31.

FIG. 8 is a flow chart showing a control to be executed in CPU 31 of certificate server 3.

FIG. 9 is a flow chart showing a control to be executed in CPU 31 of certificate server 3.

FIG. 10 is a flow chart showing a control to be executed in CPU 41 of image storage server 4.

FIG. 11 is a flow chart showing a control to be executed in CPU 51 of print server 5.

FIG. 12 is a flow chart showing a control to be executed in CPU 51.

FIG. 13 is a flow chart showing a control to be executed in CPU 13.

FIG. 14 is a flow chart showing a control to be executed in CPU 41.

FIG. 15 is a flow chart showing a control to be executed in camera phone 1.

FIG. 16 is a view showing a display example right after a picture is taken.

FIG. 17 is a block diagram showing a camera system of a second embodiment.

FIG. 18 is a flow chart showing an image data extraction control to be executed in in-vehicle computer 201.

FIG. 19 is a flow chart showing an image processing control to be executed in in-vehicle computer 201.

FIG. 20 is a flow chart showing a control to be executed in in-vehicle computer 201.

FIG. 21 is a view showing a screen example to be displayed on monitor 107.

FIG. 22 is a view showing an image display example to be displayed on monitor 107.

FIG. 23 is a flow chart showing a control to be executed in in-vehicle computer 201.

FIG. 24 is a flow chart showing a control to be executed in in-vehicle computer 201.

FIG. 25 is a flow chart showing a control to be executed in in-vehicle computer 201.

FIG. 26 is a flow chart showing a call control to be executed in in-vehicle computer 201.

FIG. 27 is a flow chart showing a control to be executed in in-vehicle computer 201.

FIG. 28 is a view showing a display example of a navigation screen.

FIG. 29 is a flow chart showing a driving route calculation control to be executed in in-vehicle computer 201.

FIG. 30 is a display example view showing driving route information in a hotspot mode.

FIG. 31 is a flow chart showing a driving route calculation control to be executed in in-vehicle computer 201.

FIG. 32 is a flow chart showing a communication control to be executed in in-vehicle computer 201.

FIG. 33 is a flow chart showing a control to be executed in in-vehicle computer 201.

FIG. 34 is a view showing a display example of a print order content.

FIG. 35 is a view showing a display example of information on a pickup location and a print charge.

FIG. 36 is a flow chart showing a control to be executed in print sever 301.

FIG. 37 is a flow chart showing a control to be executed in in-vehicle computer 201.

FIG. 38 is a flow chart showing an image control to be executed in in-vehicle computer 201.

FIG. 39 is a flow chart showing a designated location storage control to be executed in in-vehicle computer 201.

FIG. 40 is a flow chart showing an album control to be executed in in-vehicle computer 201.

FIG. 41 is a flow chart showing mail control to be executed in in-vehicle computer 201.

FIG. 42 is a flow chart showing a memory control to be executed in in-vehicle computer 201.

FIG. 43 is a view showing a selection screen.

### DETAILED DESCRIPTION OF THE PREFERRED EMBODIMENT

With reference to the accompanying drawings, embodiments of this invention will be hereinafter described.

### First Embodiment

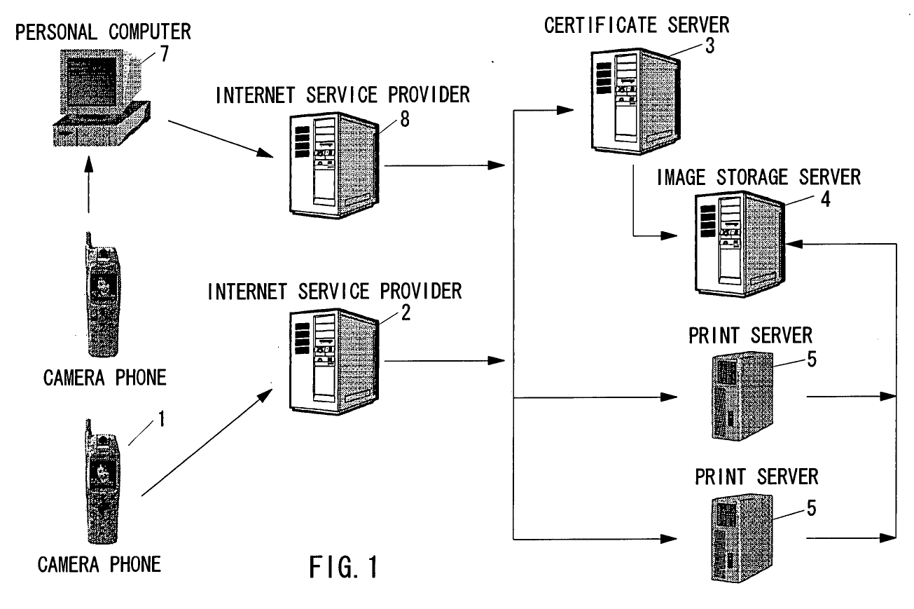

FIG. 1 is a functional block view for explaining an outline of a first embodiment in which a camera system of a first embodiment includes cell phone with a camera 1 (hereinafter referred to as camera phone 1), Internet providers 2 and 8, certificate server 3, image storage server 4 and print server 5.

Camera phone 1 is a cell phone to which digital camera abilities are added. On top of call abilities as a cell phone, camera phone 1 is provided with e-mailing and web browsing abilities as a terminal of the Internet. Internet provider 2 is an Internet service Internet provider that provides an Internet service run by a communication carrier. Certificate server 3 is a computer that certificates whether a user is registered according to user information sent out from camera phone 1. And in certificate server 3 is stored a latest version of image optimizing program software. Image server 4 is a computer that stores an image data taken with camera phone 1. Print server 5 is a computer that executes a print processing of an image data taken with camera phone 1. Print server 5 is installed in a mini laboratory. And in print server 5 is stored a latest version of image quality optimizing program software.

Print server 5 can get a latest version of image optimizing program software accessing certificate server 3. For example, in a case where latest compression routines are developed, by changing image processing program software stored in print server 5, an image data can be compressed by a latest compression routine. Accordingly, even a function that could be boosted by an image processing circuitry, not by a camera itself can be boosted. Also, variety of image processing that a digital camera cannot accomplish due to a program capacity, CPU load and the like can be performed. Printer 6 connecting to print server 5 is a printer that prints out a hardcopy of an image data in accordance with an instruction from print server 5. Printer 6 may be any printer of an inkjet type, a laser type or a type in which an image data is optically exposed on a silver halide sensitive paper. Personal computer 7 is a computer terminal that a user uses.

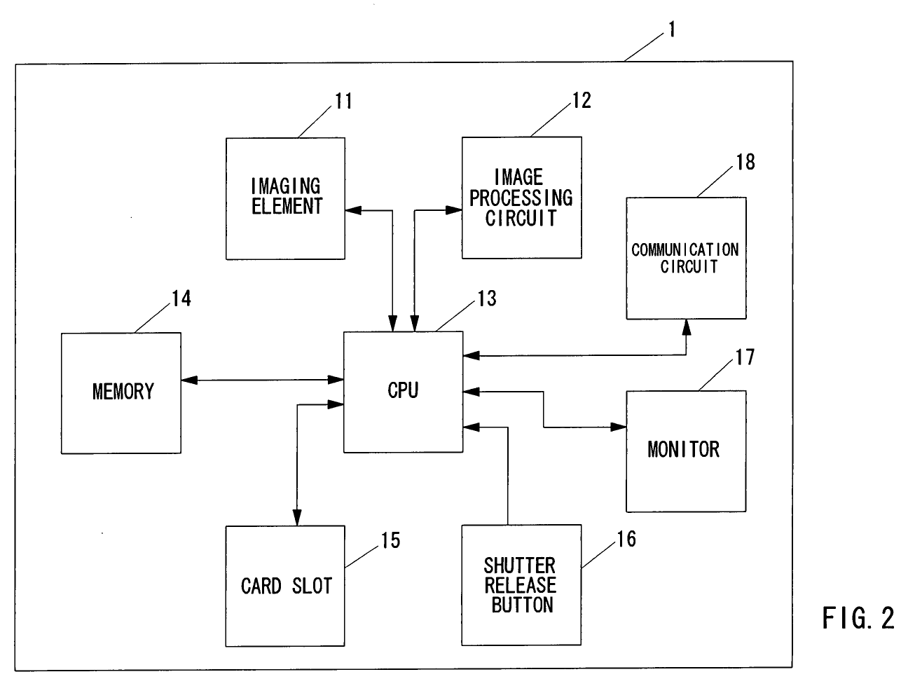

Personal computer 7 can communicate with certificate server 3 and print server 5 via Internet provider 8. And personal computer 7 has the same program software that optimizes an image quality with respect to an image data taken with camera phone 1 and so as print server 5 has. Personal computer 7 connecting to camera phone 1 receives an image data such as a RAW image data and the like taken with camera phone 1 and then can optimize the received RAW image data and the compressed image data by image optimizing program software in the same way like print server 5. An identification data is attached to the image data optimized by this program software so that executing the same image optimizing program software in print server 5 once again can be avoided. However, there is a case where image optimizing program software is updated. Print server 5 as hereinafter described is always updated to a latest version of program software. If a version of image optimizing program software in personal computer 7 is older than that in print server 5, print server 5 performs an image processing additionally by a difference in a version with respect to the image data optimized in personal computer 7. Internet provider 8 is an Internet service provider that provides the Internet service run by a business organization different from a cell phone business company. More specifically, a construction of a major component will be described hereinafter. First, camera phone 1 will be explained. FIG. 2 is a block view of a construction of camera phone 1.

As described in FIG. 2, camera phone 1 includes imaging element 11, image processing circuit 12, CPU 13, internal memory 14, card slot 15, shutter release button 16, monitor 17, communication circuit 18 and so. It is needless to say that camera phone 1 is provided with necessary circuits and operation buttons required to use such telephone, e-mailing and the Internet abilities, but an explanation there of will be omitted here.

Imaging element 11 is an element that captures a subject and, for example, CCD (Charge Coupled Device) made of the order of 200 mega pixels. Imaging element 11 can output an image data of the order of 350,000 pixels by reading out/pixel-skipping from 200 mega pixels. Image processing circuit 12 is designed to become best suitable for processing an image data of the order of 350,000 pixels read out/pixel-skipped from CCD. CPU 13 is a circuit that controls camera, communication and other abilities of camera phone 1.

Internal memory 14 is a nonvolatile semiconductor memory that stores program software to execute camera, communication and other abilities of camera phone 1. Card slot 15 is a port where a memory card is inserted in a slot and data like an image data is written to a loaded memory card. Shutter release button 16 is a button for a user to operate when starting to shoot. A button dedicated for use in a shooting start may be provided or shutter release button 16 may double as an operation button for executing other abilities. Monitor 17 is to display such an image data and uses, for example, a liquid crystal display and the like. Communication circuit 18 is a circuit to send out externally data such as an image data.

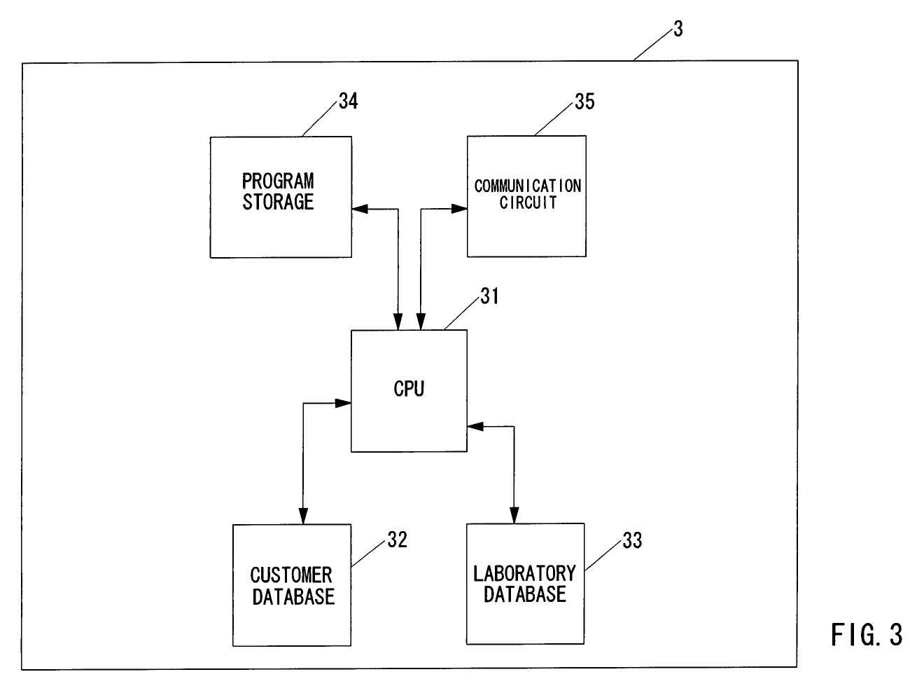

Next, certificate server 3 will be explained. FIG. 3 is a block view for explaining a construction of certificate server 3. As described in FIG. 3, certificate server 3 is provided with CPU 31, customer database 32, laboratory database 33, program storage section 36, communication circuit 35 and so. CPU 31 is a circuit to execute certificate program software and the like of certificate server 3. Customer database 32 is a database where information about a user using a camera phone is registered. Laboratory database 33 is a database where information about a printing laboratory is registered. Program storage section 34 is provided with program software to certificate a user. Also, in program storage section 34 is always stored latest image optimizing program software. Communication circuit 35 is a circuit to communicate data such as an image data with other apparatus over a communication network of the Internet and so.

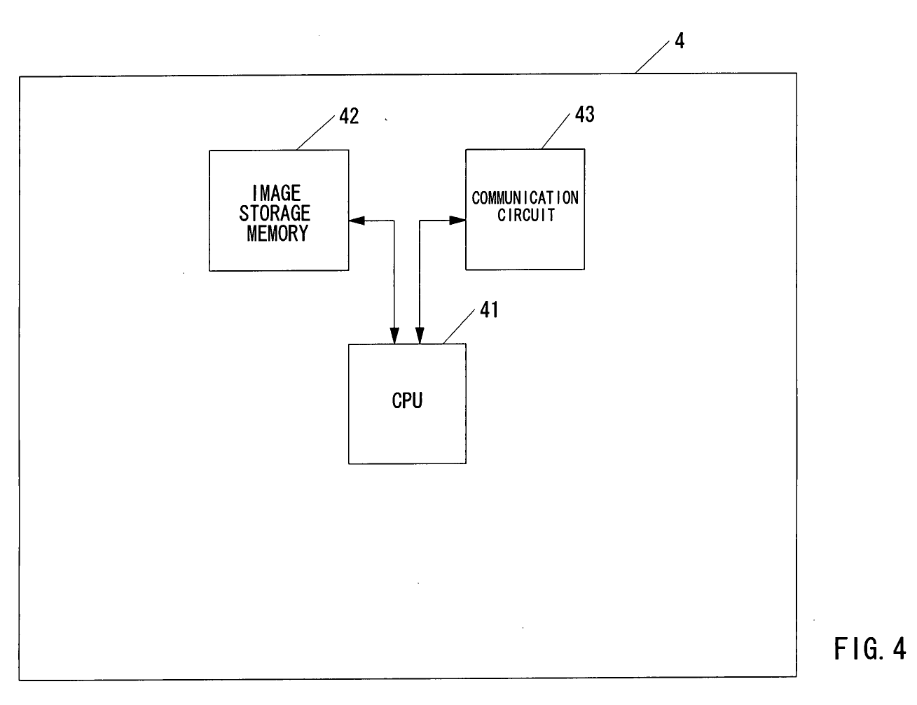

Next, image storage server 4 will be explained. FIG. 4 is a block view showing a construction of image storage server 4. As shown in FIG. 4, image storage server 4 is provided with CPU 41, image storage section 42, communication circuit 43 and the like. CPU 41 is a circuit to execute image storage program software and the like of image storage server 4. Image storage section 42 is a memory that stores an image data of a user. Communication circuit 43 is a circuit to communicate data such as an image data with other apparatus over a communication network of the Internet and so.

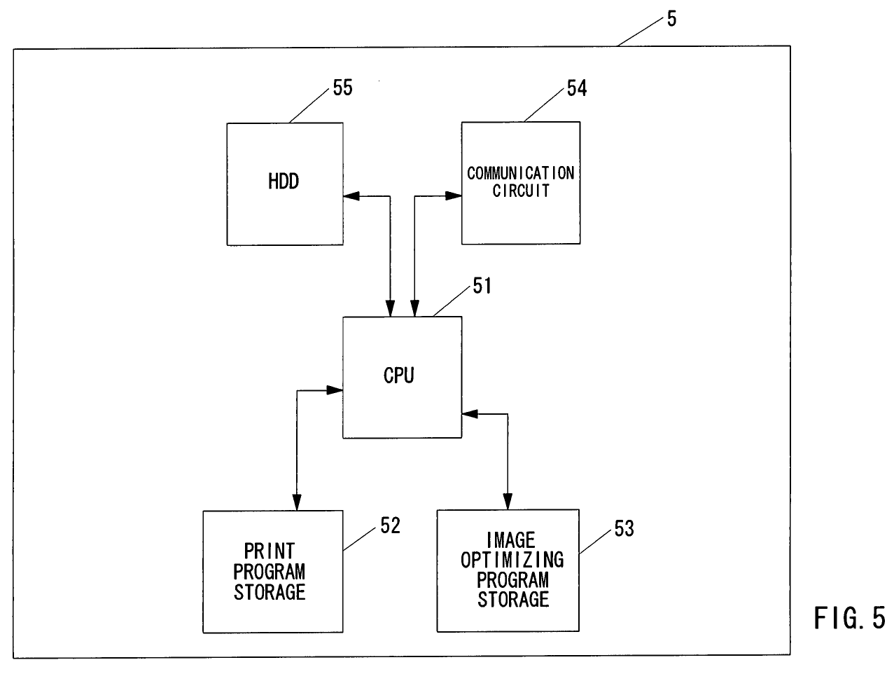

Next, print server 5 will be explained. FIG. 5 is a block view showing a construction of print server 5. As shown in FIG. 5, print server 5 is provided with CPU 51, print program software storage section 52, image optimizing program software storage section 53, communication circuit 54, hard disk drive 55 and the like. CPU 51 is program software to execute print program software and image optimizing program software and the like of print server 5. Print program software storage section 52 is a memory that stores program software realizing a print of an image data by printer 6. Image optimizing program software storage section 53 is memory that optimizes an image quality of an image data. Communication circuit 54 is to communicate data such as an image data with other apparatus over a communication network of the Internet and so. Hard disk drive 55 is a memory that temporarily stores a received image data.

Next, a control outline to be executed in this system of this embodiment will be described. First, camera phone 1 sends out a certificate data by internally stored image transfer program prior to sending out an image data. Certificate data 3 sent out from camera phone 1 is delivered to certificate server 3 via Internet provider 2. Certificate server 3 executes certification based upon the certificate data and once certification is cleared, certificate server 3 sends out to camera phone 1 address information of print server 5 via Internet provider 2.

Camera phone 1 of a user certified by certificate server 3 sends out to print server 5 an image data. The image data is directly sent out to one of a plurality of print servers 5 arranged at a plurality of mini laboratories. A laboratory with witch the same user placed a print order at a previous time, a laboratory close to a pick-up location the user selects, near to a home address of the user and the like are selected. Such a selection of a laboratory is made by certificate server 3 and the image data is automatically sent out to the laboratory selected by certified server 3. Or an image data may be sent out to a less busy laboratory detecting an operating status of a printer. Naturally, image data of the same user that is sent out during a certain period of time is configured such that the image data is sent out to the same laboratory to make a print.

Like this, an image data sent out by camera phone 1 is dispersedly received by a plurality of servers, so even if the image data sent out from camera phone 1 is a large volume, there is no traffic concentration on a single server only. Thus, a breakdown of a server due to traffic decreases. A certificate operation is all performed by certificate server 3, so there is no worry about a security because each print server 5 does not need to perform certification. And, there is no need to build a complicated certification system at each of print server 5.

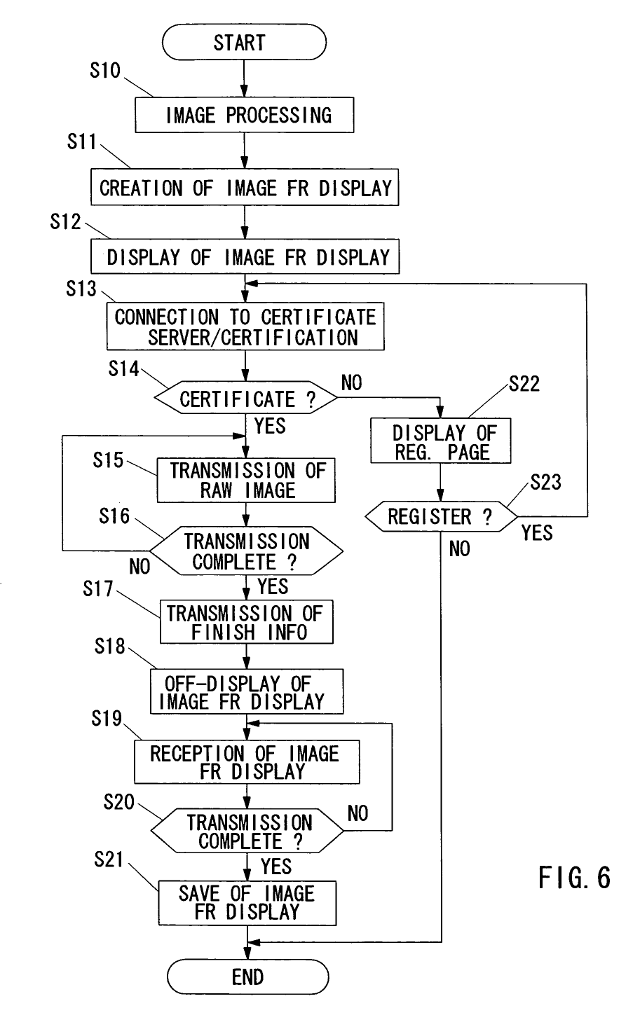

Next, a system control of the embodiment of this invention will be specifically explained. First, a control to be executed in camera phone 1 will be explained. FIG. 6 is a flow chart showing a control to be executed by CPU 13. This flow will start when a user operates shutter release button 16 of camera phone 1 in a camera mode.

In step S10, an imaging process is performed by imaging element 11. In step S11, an image for display to display on monitor 17 is created from an output data of imaging element 11 obtained by the imaging process. The image for display may be an image of a resolution sufficient for a display on monitor 17, so the image for display is created by skipping pixels from the output data of imaging element 11. In step S12, the image for display is displayed on monitor 7. In step S13, certificate server 3 is connected via the Internet and then a certificate data including user information necessary for certificate server 3 to work on certification is sent out to certificate server 3. In step S14, it is detected whether or not a certificate confirmation signal is received from certificate server 3. When reception of a certificate confirmation signal is detected, a flow proceeds to step S15, but when a certificate confirmation signal is not received yet, namely, certificate is denied, a flow proceeds to step S22 where address information to connect to print server 5 to which an image data is to be delivered is sent out along with a certificate signal from certificate server 3.

Also, in step S22, a screen received from certificate server 3 and for registering a new user to receive a service is displayed. In step S23, it is detected whether or not a user registration operation is executed in accordance with a user registration screen. When the user registration operation is executed, a flow gets back to step S13 where certification is effected again. When the user registration operation is not executed, this flow is finished.

On the other hand, in step S15, a RWA image data that is almost the same as the output data from imaging element 11 is sent out to print server 5 in accordance with address information received from certificate server 3. At this time, information such as a model name of a camera phone, a shooting situation, a file format at storage is sent out with attachment to the RAW image data. And, when an image in transit is set to be printed, a print order data is sent out with attachment to the RAW image data too.

In step S16, it is detected whether or not transmission of the RAW image data is complete. When transmission is complete, a flow proceeds to step S17, but when transmission is not complete, a flow gets back to step S15 where transmission is continued. In step S17, end tag information indicative of transmission of the imagined RAW image data being complete is sent out to print server 5. In step S18, a screen displayed on monitor 17 is changed from an image data for reproduction to a moving image data while imagining. Accordingly, a user can get to know that a next shooting becomes available or transmission of an image data is just complete. A text or the like may let you know of completion of image data transmission. In step S19, an image data for reproduction is received from image storage server 4. The image data for reproduction is an image data to be displayed on monitor 17 when viewing an image data by camera phone 1 and as the data for reproduction is the image data based upon data image-processed by print server 5, the image data for reproduction is closer to an image quality (color and contrast) of an image data to be stored and printed than that of an image data for display created in step S11 right after shooting. In step S20, it is detected whether or not reception of the image data for reproduction is complete. When reception is complete, a flow proceeds to step S21, but when reception is not complete, a flow proceeds to step S19 where reception of the image data for reproduction is continued. In step S21, the image data for display created in step S11 is erased and the image data for reproduction received from image storage server 4 is stored in a memory card.

Accordingly, as camera phone 1 receives an image data for reproduction performed by an optimizing processing from a server after an image processing was finished and stores the received image data for reproduction by replacing an old image data for reproduction automatically, the optimize-processed image data for reproduction can be obtained. An image data is not always necessary to be sent out using communication abilities of camera phone 1. For example, an image data stored in a memory card of camera phone 1 is retrieved by a personal computer and can be sent out using a personal computer. To the image data stored in the memory card is attached lens characteristics information.

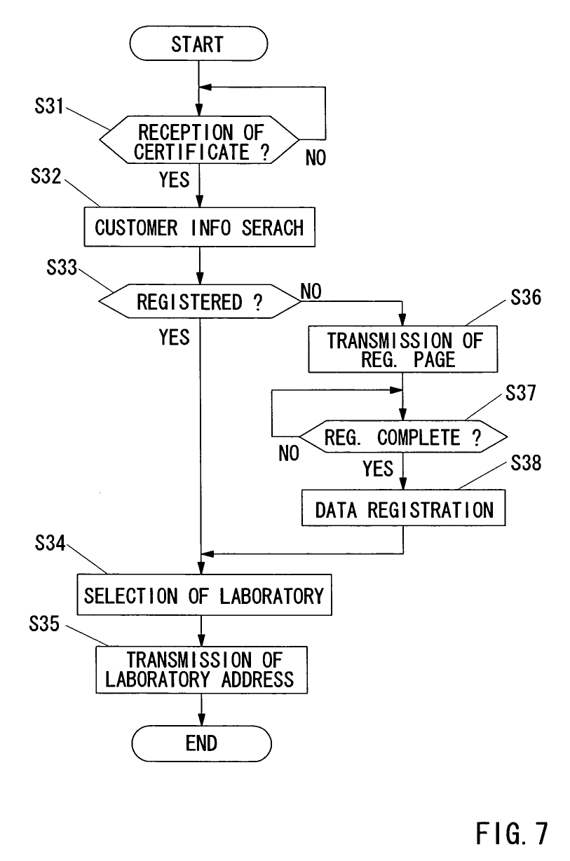

Next, a control to be executed in certificate server 3 will be specifically explained. First, a control to be executed between certificate server 3 and camera phone 1 will be explained. FIG. 7 is a flow chart showing a control to be executed in CPU 31. First, in step S31, it is detected whether or not certificate data including user information is received from camera phone 1. When certificate data is received, a flow proceeds to step S32, but when certificate data is not received, a flow stays there to receive certificate data. In step S32, it is checked whether or not a received certificate data is registered in customer information of customer database section 32. In step S33, it is detected whether or not the received certificate data is registered in customer information from a checking result. When the data is registered, a flow proceeds to step S34, but when the data is not registered, a flow proceeds to step S36.

In step S34, a suitable laboratory is selected based upon customer information about a certified user and laboratory information obtained from laboratory data base storage section 33. In step S35, address information of print server 5 to be able to transmit an image data to print server 5 of a selected laboratory is sent out. In step S36, a registration page for causing a new customer to make a registration is sent out to camera phone 1. In step S37, it is detected whether or not registration information in accordance with the registration page is received from camera phone 1. When the information is received, a flow proceeds to step S38, but when the information is not received, detection of reception of the registration information is continued. In step S38, customer information is registered in customer database storage section 32 of certificate server 3 based upon the received registration information. After the registration is complete, a flow proceeds to step S34.

With such a control, corresponding to a user of camera phone 1, a laboratory that performs an optimizing processing on an image data and prints out a hard copy of the image data is selected from a plurality of laboratories, so a processing does not concentrate on a single laboratory and thus a print server is avoided from being down.

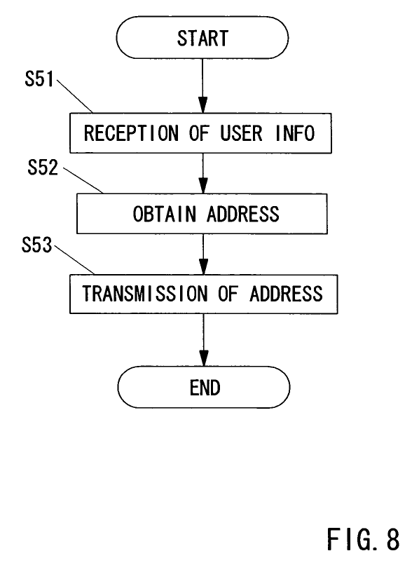

Next, a control of certificate server 3 to be executed between image storage server 4 and certificate server 3 will be explained. FIG. 8 is a flow chart showing a control to be executed in CPU 31 of certificate server 3. This flow will be started detecting a connection to image storage server 4. First, in step S51, user information is received from image storage server 4. In step S52, by accessing customer registration data and searching therein by the received user information, address information to connect to a terminal of a user is obtained. In step S53, address information of the user is sent out to image storage server 4.

With such the control, as image storage server 4 can connect to the terminal of a user without storing a terminal address of the user, there is no need to secure a memory capacity for storing user information nor worry about leaking user information.

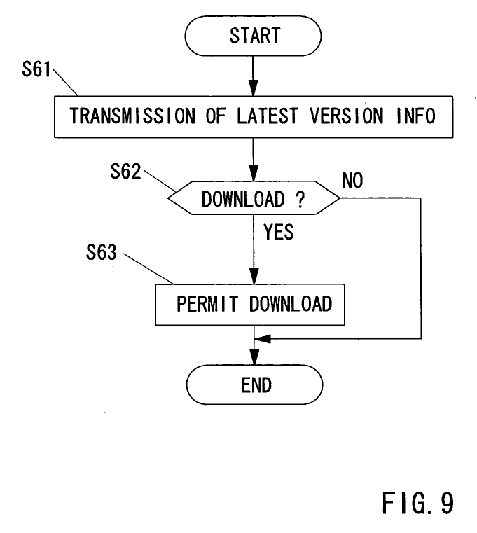

Next, a control of certificate server 3 to be executed between print server 5 and certificate server 3 will be explained. FIG. 9 is a flow chart showing a control to be executed in CPU 31 of certificate server 3. This flow will be started by detecting a connection to print server 5. First, information on the latest version of an image optimizing program is sent out to print server 5. Instep S62, it is detected whether or not print server 5 instructs to download the latest image optimizing program. A download instruction will be implemented when an optimizing program stored in print server 5 is not latest. When the download is instructed, a flow proceeds to step S63, but when the download is not instructed, a flow is finished. In step S63, the download of the latest image optimizing program by print server 5 is permitted.

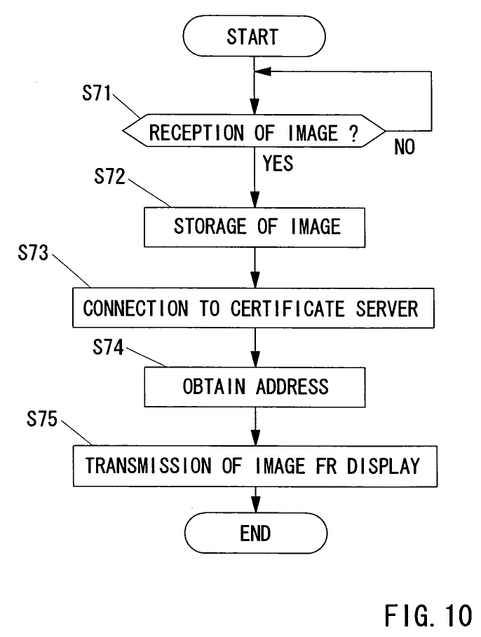

With such the control, the latest image optimizing program can be always provided to print server 5. Next, a control to be executed in image storage server 4 will be explained. FIG. 10 is a flow chart showing a control to be executed in CPU 41 of image storage server 4. This flow will be started by detecting a connection to print server 5.

First, in step S71, it is detected whether or not an image data is received from print server 5. When the image data is received, a flow proceeds to step S72, but when the data is not received, detection is continued. In step S72, the received image data is stored in a hard disk drive connected to an image storage server. In step S73, certificate server 3 is connected. In step S74, an address of a user is obtained from user information attached to the image data. In step S75, based upon the obtained address of the user, an image data for reproduction is sent out to the user. Accordingly, in this system in which an image data is configured to be sent/received directly between image storage server 4 and print server 5 not via certificate server 3, communication traffic of one of servers such as certificate server 3 can be reduced and a server can be avoided from being down.

Next, a control to be executed in print server 5 will be explained. Print server 5 delivers an image data to printer 6 and controls printer 6. An image processing is performed on the received image data. When the received image data is a RAW data, interpolation, compression etc are performed on the image data. Information about lens characteristics like distortion, chromatic aberration, light fall-off away from the center of an image and so is received in advance or along with the image data. With the use of this lens information, the image processing such as interpolation, compression etc is performed on the received image data. Anyway, lens information may be stored in a running program in advance.

Also, lens characteristics and the like may be derived by letting a specific subject be taken by a user and sending an image data thereof. Lens characteristics may be used such that lens characteristics are stored per each of users when an image data is sent out from a corresponding user and an image processing is performed on the image data in accordance with the lens characteristics and then the image data is processed to an optimum image data. Prior to camera phone 1 shipment, lens characteristics of each lens may be collected. Also, a correction instruction of an image from a user may be caused to be learned. Owing to the foregoing, as lens characteristics eradicate an image flaw, an image data that is a user's cup of tea can be created.

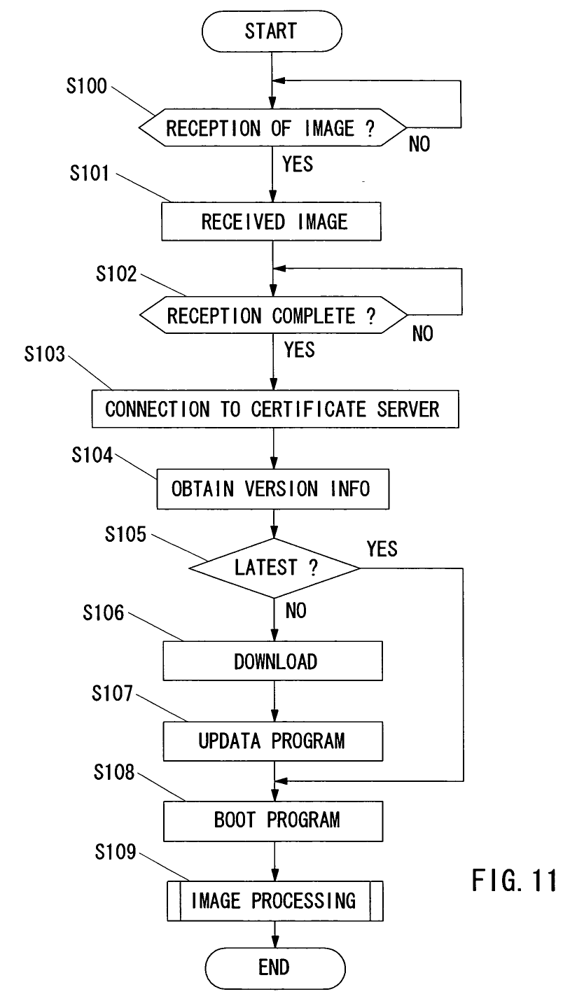

A control to be executed in print server 5 will be explained hereinafter with reference to a flow chart. FIG. 11 is a flow chart showing a control to be executed in CPU 51 of print server 5. First, in step S100, it is detected whether or not an image data is received via a communication line. When the image data is received, a flow proceeds to step S101, but when the data is not received, detection is continued. And, in step S101, the received image data is stored in hard disk drive 55. Then, in step S102, it is detected whether or not reception of the image data is complete. Reception or non-reception can be detected by finish tag information sent from a user along with the image data. When reception is complete, a flow proceeds to step S103, but when reception is not complete, a flow gets back to step S101 and then reception and storage of the image data are repeated.

In step S103, print server 5 is connected to certificate server 3 via a communication line. In step s104, information on a latest version of an image optimizing program is obtained from certificate server 3. In step S105, as compared with a version of an image optimizing program stored in print server 5, it is judged whether or not a registered image processing program is latest. When the program is latest, a flow proceeds to step S108. When the program is not latest, a flow proceeds to step S106 where data to update the version is downloaded from certificate server 3. In step S107, old data is replaced with latest data. With updating of the image optimizing program to the latest version thereof, an image data taken with a new camera can be caused to be handled and the latest image processing and compression techniques can be also caused to be used. And a defect available in the old version can be fixed.

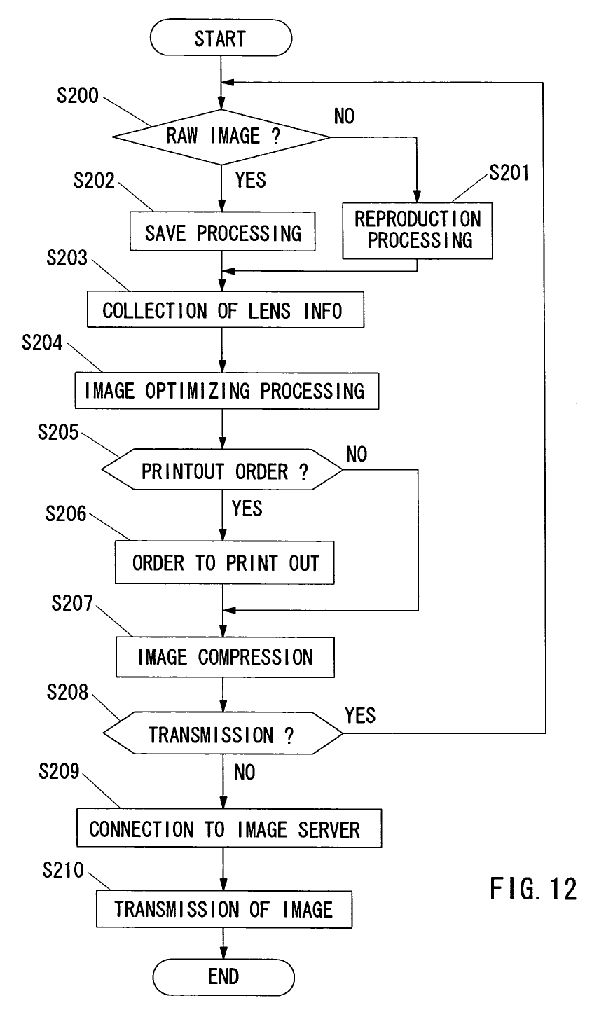

In step S108, the image optimizing program is booted. In step S109, the image optimizing processing is performed on the received image data. An image optimizing processing control to be executed in step S109 will be explained. FIG. 12 is a flow chart showing a control to be executed in CPU 51.

First, in step S200, a data format of the received image data is detected and it is judged whether or not the data format is a RAW data. In a case of the RAW data, a flow proceeds to step S202, but in the case of the non-RAW data, a flow proceeds to step S201. In step S201, the received image data is processed for reproduction, in which, in a case of an image data compressed in JPEG-type format etc, an expansion processing is effected to create an image data capable of being image-processed.

In step S202, an interpolation processing is performed on the received image data of a RAW-format data and then an optimum image is created. In step S203, aberration information etc of a camera in use is obtained. In step S204, based upon the obtained information, an image processing to eliminate aberration etc is performed. In step S205, it is detected whether or not a print is ordered with respect to the image performed by an image processing based upon the received data. When the print is ordered, a flow proceeds to step S206, but when the print is not ordered, a flow proceeds to step S207.

Then, in step S206, information such as the number of print hard copies, a print size and the like in accordance with the print order and image information are sent out to a printer. In step S207, further following information on a storage method of the received data, processing like an image size conversion, an image compression and so is performed on the image performed by the image processing and the performed image is stored in a hard disk drive. In step S208, it is detected whether or not there is an image data in the hard disk drive that was sent out from the same user and the image processing was not performed on. When there is the data therein, a flow gets back to step S200 where processing from step S200 to step S207 is performed on a new image data. When there is not the data therein, a flow proceeds to step S209. In step s209, print server 5 is connected to image storage server 4. In step S210, the image data performed by the image processing and stored in hard disk drive 55 is sent out to image storage server 4.

Camera phone 1 is provided with abilities to perform an image editing process such as a cropping, composition, image editing, framing and the like with respect to an image data. At an editing, an editing work is virtually performed in camera phone 1 using an image data for display as well. Camera phone 1 sends out to image storage server 4 information about content of the performed image editing when the image editing is finished. Image storage server 4 performs the image editing with respect to a stored image data based upon information about content of the image editing.

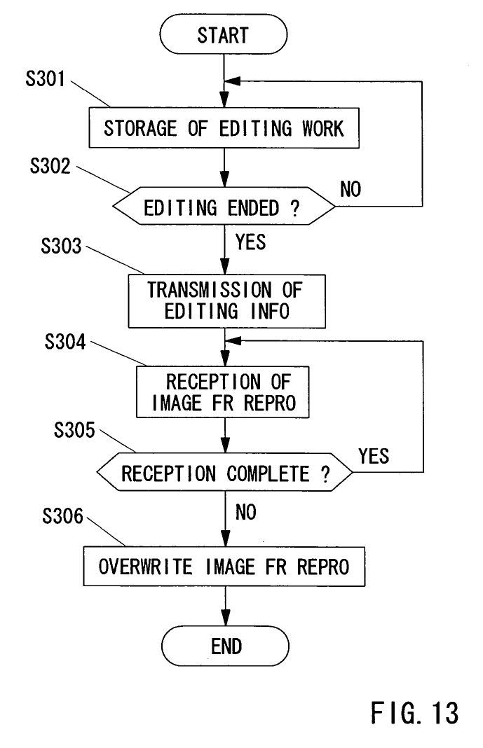

An editing control to be executed in a system of this embodiment will be more particularly explained hereinafter. First, an editing control to be executed in camera phone 1 will be explained. FIG. 13 is a flow chart showing a control to be executed in CPU 13. This flow will be started when an editing work is started in camera phone 1. In step S301, content of an image editing work is stored. In step S302, it is detected whether or not the editing work is finished. When the editing work is finished, a flow proceeds to step S303, but when the editing work is not finished, storage of content of the editing work is continued. In step S303, a content data of the stored editing work and information about an image data to be edited are sent out to image storage sever 4. In step S304, an image data for display is received from image storage server 4. In step S305, it is detected whether or not reception of the image data for display is finished. When the reception thereof is finished, a flow proceeds to step S306, but when the reception thereof is not finished, reception of the image data for display is continued. In step S306, the received image data is stored erasing the stored image data for display.

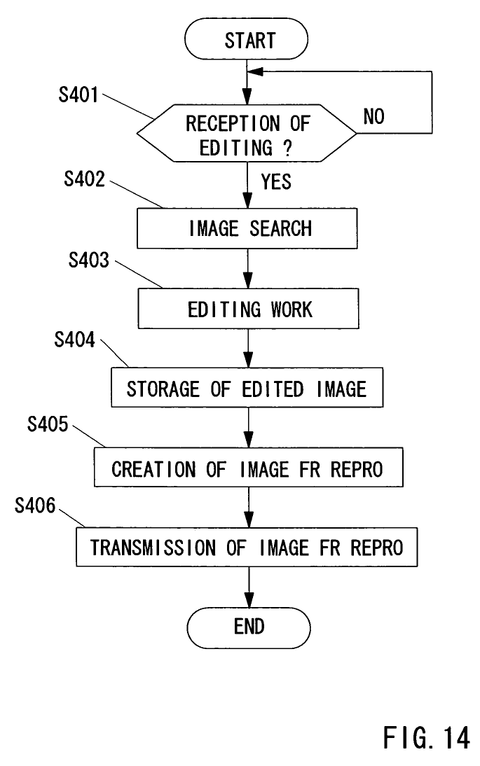

Next, a control to be executed in image storage server 4 will be explained. FIG. 14 is a flow chart showing a control to be executed in CPU 41. In step S401, it is detected whether or not information about the image data to be edited and the content data of the editing work are received. When the information and the content data thereof are received, a flow proceeds to step S402, but when the information and the content data thereof are not received, detection of the reception is continued. Instep S402, an image data to be performed by an editing work is searched for from image storage memory 42. In step s403, an image editing work is performed on the image data to be edited in accordance with the content data of the editing work. In step S404, the edited image data is stored erasing the original image data in image storage memory 42. In step S405, an image data for reproduction to be reproduced in camera phone 1 is created from the edited image data. In step S406, the created image data for reproduction is sent out to camera phone 1.

With such the control, the image editing performed in camera phone 1 is reflected on the image data stored in image storage server 4 too. Also, the image data for reproduction in camera phone 1 becomes automatically an image corresponding to the edited image. And, there is a digital camera that has an ability to reproduce and display a captured image data during a given period of time right so that the captured image can be confirmed after a picture is taken. Also, there is provided a digital camera with an ability that easily deletes a captured image during a given period of time of a reproduction display by a simple operation. Camera phone 1 of this embodiment sends out an image data after a picture is taken. If camera phone 1 is provided with the ability to easily delete as described above, it becomes necessary to delete an image data that was sent out and thus a communication cost or a load of a control ends up increased. Therefore, camera phone 1 is controlled such that camera phone 1 stands by communication during a given period of time after a picture is taken and the only an image data that has not been executed by a delete operation during the period of time is sent out.

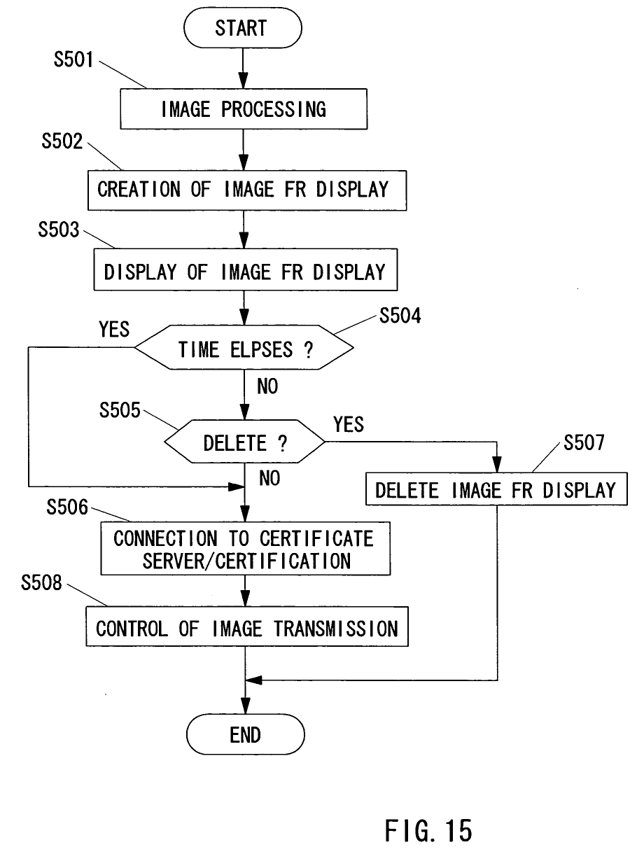

FIG. 15 is a flow chart showing a control to be executed in camera phone 1. This flow will be started when a user presses shutter release button 16 of camera phone 1 in a camera mode. And after connecting to certificate server 3, the same controls as in step S14 of FIG. 6 are executed, so steps up to a connection to certificate server 3 will be explained.

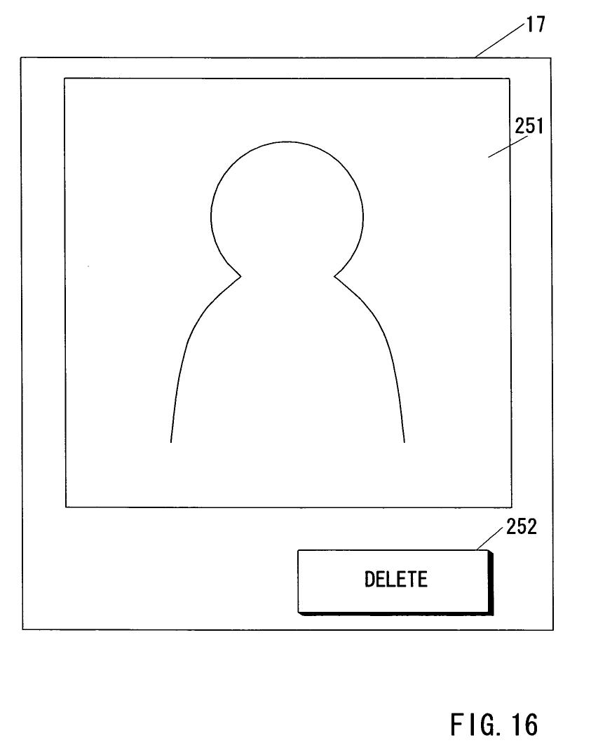

In step S501, an imaging processing is performed by imaging element 11. In step S502, an image for display to display on monitor 17 is created from an output data of imaging element 11 obtained by the imaging processing. The image for display may be an image of a resolution satisfying a display on monitor 17, so pixels are skipped from the output data of imaging element 11 and then the image for display is created. In step S503, a screen asking to delete is displayed on monitor 17 along with the image for display. FIG. 16 shows an example of the display in which delete button 252 is displayed at a lower portion of a right side of captured image 251. An operation of delete button 252 is configured such that an image data of image 251 can be easily deleted. Anyway, there is provided a touch panel in monitor 17 and then the delete operation is performed with a direct touch on delete button 252. In step S504, it is detected whether or not a given period of time has elapsed since the image for display was displayed. When the given period of time has elapsed, a flow proceeds to step S506, but when the period thereof has not elapsed, a flow proceeds to step S505 where it is detected whether or not delete button 252 is operated. When delete button 252 is operated, a flow proceeds to step S507 where the image data for display is deleted, but when delete button 252 is not operated, a flow gets back to step S504.

In step S506, certificate server 3 is connected via the Internet and then a certificate data including user information necessary for certificate server 3 to perform a certification work is sent out to certificate server 3. In step S508, the image transmission control as described above like transmission of a RAW image data to print server 5 is executed.

Accordingly, communication cost and a load of a control of camera phone 1 that sends out an image data of a large capacity such as a RAW image data can be reduced.

### Second Embodiment

A camera system of a second embodiment of this invention will be explained. A camera system of a second embodiment is a system that works with an in-vehicle computer installed in a vehicle and, more particularly, a camera system in a rental vehicle will be explained as an example.

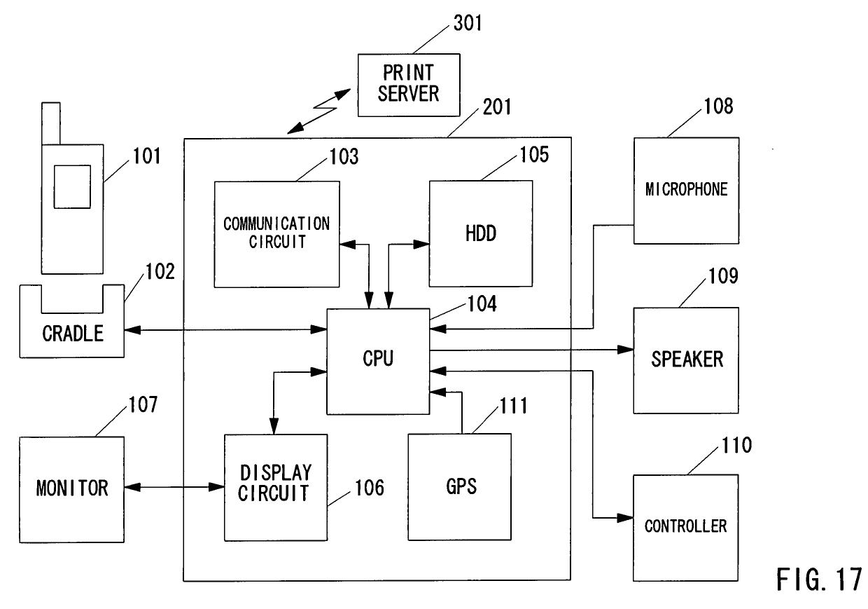

FIG. 17 is a block view showing a camera system of a second embodiment. In FIG. 17, a camera system includes primarily camera phone 101, cradle 102, in-vehicle computer 201, monitor 107, microphone 108, speaker 109 and controller 110. In-vehicle 201 is provided with communication circuit 103, CPU 104, hard disk drive (HDD) 105, display circuit 106 and GPS sensor 111, whereas print server 301 is a server computer that receives a print order from in-vehicle computer 201.

Camera phone 101 is provided with abilities such as phone abilities as a cell phone, e-mailing and web browsing abilities as a terminal of the Internet like camera phone 1 of the first embodiment. Also, there is provided a camera element and thus camera phone 101 functions as a digital camera. There is provided a memory card slot wherein an image data taken with a camera element is stored in an inserted memory card. And camera phone 101 functions as a key of a rental vehicle too. Namely, a door lock, a door lock release etc can be instructed remotely. In a case of an engine-driven vehicle, a start-engine and a stop-engine can be also instructed. In order to let camera phone 101 have a key ability, it is necessary to register in camera phone 101 key information peculiar to a rental vehicle to be rented.

Cradle 102 is connected to in-vehicle computer 201 wherein cradle 102 is used to send/receive a data between camera phone 101 arranged in a vehicle and in-vehicle computer 201. And cradle 102 is provided with an ability to recharge a battery power of camera phone 101. Further, there is provided an operation button in cradle 102 to start transfer of an image data within camera phone 101 arranged in a vehicle to in-vehicle computer 201. A user can select in advance via camera phone 101 when to start transfer of an image data either upon arrangement of camera phone 101 in a vehicle only or upon an operation of the operation button and set the selection thereupon.

In-vehicle computer 201 is provided with communication circuit 103, CPU 104, HDD 105, display circuit 106 and GPS sensor 111 and acts the same function as a personal computer. Communication circuit 103 is a circuit to send/receive a data with a wireless connection to an external server computer. CPU 104 is a circuit that performs a processing to realize abilities to be executed in-vehicle computer 201. HDD 105 stores programs to realize variety of abilities and also is an apparatus to store variety of data. Display circuit 106 is a circuit that creates a screen to be displayed on monitor 107. GPS sensor 111 is a sensor used to detect positioning information of a rental vehicle and causes car navigation abilities to be realized.

An operation of a camera system in a second embodiment will be explained. In-vehicle computer 201 is always put on standby and reception of any signal can switch a main power of in-vehicle computer 201 on. With this, incidents such as robbery or theft are gotten ready for. When camera phone 1 is connected to cradle 102, a power is turned on too and camera phone 1 enables a program working together with camera phone 1 to be run.

More particularly, it is detected whether or not there is a taken image data of a large size within camera phone 101 and when there is the image data of the large size, extracting the image data is executed. Also, a battery power of camera phone 101 is recharged. Transfer of an image data may be implemented using a wireless communication like Bluetooth etc, not via cradle 102. Also, a connection of cradle 102 to in-vehicle 201 may use a wireless communication like Bluetooth etc, not a wired cable.

In-vehicle computer 201 creates an image data by performing an interpolation process of a RAW data received from camera phone 101. Also, in-vehicle computer 201 is provided with abilities to perform JPEG compression of an image data received from a camera by software and reproduce. In addition to compression and reproduction of an image data for reproduction, these abilities are used for reproducing an image data downloaded from a web. In-vehicle computer 201 enables an image data extracted from camera phone 101 to be viewed on monitor 107. A print can be ordered while viewing on monitor 107. When a print is ordered, it is detected whether or not a communication is communicable. When the communication is not communicable, an image data and order information are temporarily stored in HDD 105 until transmission is complete.

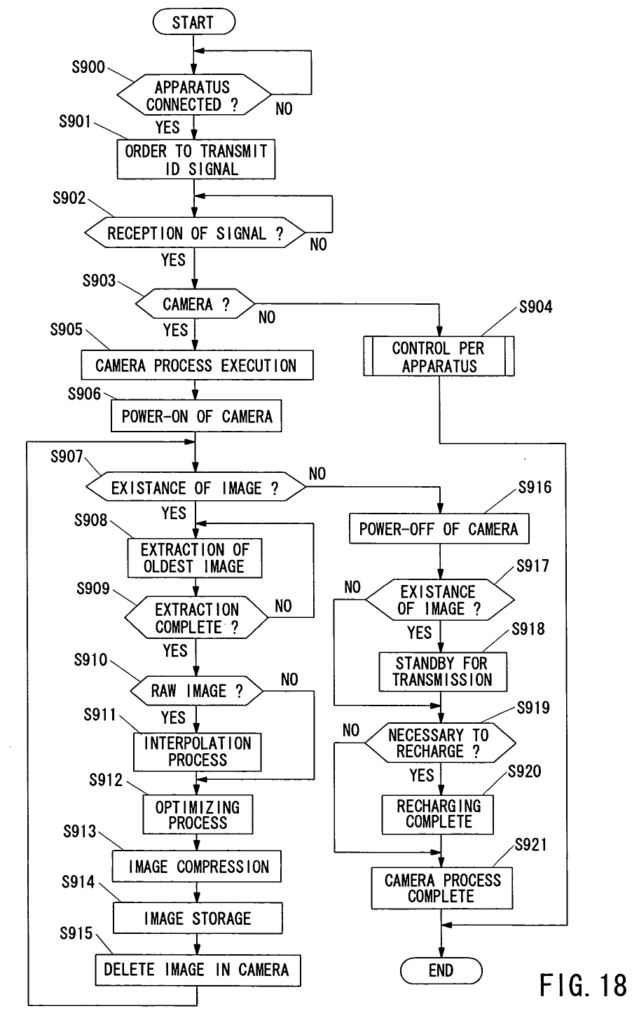

A control of an image data extraction of camera phone 101 to be executed by in-vehicle computer 201 will be explained herein after. FIG. 18 is a flowchart showing a control of an image extraction to be executed in in-vehicle computer 201. In step S900, it is detected whether or not an apparatus is connected. When the connection is detected, a flow proceeds to step S901, but when the connection is not detected, detection thereof is continued. In step S901, the connected apparatus is ordered to send an identification signal. With application of a weak current to the connected apparatus in accordance with a specification, in-vehicle computer 201 can obtain an identification signal to identify an apparatus without the use of a power of the apparatus. In step S902, it is detected whether or not the identification signal is received from the connected apparatus. When reception of the identification signal is detected, a flow proceeds to step S903, but when the reception thereof is not detected, the detection thereof is continued. In step S903, it is judged from the identification signal whether or not the connected apparatus is camera phone 101. When the apparatus is camera phone 101, a flow proceeds to step S905, but when the apparatus is not camera phone 101, a flow proceeds to step S904 where a control programmed corresponding to a connected apparatus is executed. In step S905, a program suitable for the connected camera phone 101 is read out and executed. In step S906, the program instructs to apply a current to a circuit necessary to control camera phone 101.

In step S907, it is detected whether or not there is an image data within camera phone 101 larger than a given size. Herein, an image data larger than a given size refers to a RAW image data etc, not an image data for reproduction that is created to view on a monitor of camera phone 101. When there is the image data larger than the given size, a flow proceeds to step S908. But when there is not the image data larger than the given size, a flow proceeds to step S916. In step S908, the image data lager than the given size existing within camera phone 101 is extracted. The extraction is implemented from an older image data in terms of a shooting day and time. Along with the image data, a print order data, a storage condition data etc are extracted too. The print order data is a data to place a print order with a laboratory and that includes the number of the print hard copies, a print size, a print pick-up location and the like. The storage condition data is a data that includes an image size, a compression ratio, storage location and the like at storage of the image data.

In step S909, it is detected whether or not the extraction of the image data is complete. When the extraction thereof is complete, a flow proceeds to step S910, but when the extraction thereof is not complete, a flow gets back to step S908 where the extraction thereof is continued. In step S910, it is judged whether or not the extracted image data is a RAW image data and when the image data is the RAW image data, a flow proceeds to step S911, but when the image data is not the RAW image data, a flow proceeds to step S912. In step S911, a processing like pixel interpolation etc to let the extracted RAW image data be capable of being reproduced is performed. In step S912, an image processing to optimize the extracted image data is performed. A camera phone sacrifices lens performances since it is necessary to make a camera physical structure small. Thus, effects such as aberrations and so appear in a taken image. An image processing to optimize is an image processing that lessens and eliminates effects like a chromatic aberration and the like existing in every each of a product model or a camera.

In step S913, in accordance with the storage condition data, a compression processing etc is performed on the image data. In step S914, the image data is stored in HDD 105. In step S915, the already extracted image data within camera phone 101 is instructed to be erased. When an image data is set to be stored in camera phone 101 in accordance with by the storage condition data, the image data is sent to camera phone 101 and is stored by overwrite in exchange for extracted image data. After a processing of step S915 is over, a flow gets back to step S907.

In step S916, camera phone 101 is turned off. In step S917, it is judged whether or not there is an image data on print order by analyzing the print order data. And, it is judged whether or not there is an externally stored image data by analyzing the storage condition data. When there is the image data relevant to any of the foregoing image data, a flow proceeds to step S918. When there is not the image data relevant thereto, a flow proceeds to step S919.

In step S918, the image data on print order or stored in an external computer is put on standby for transmission to an external computer. In step S919, it is detected whether or not it is necessary to recharge a battery power of camera phone 101. When recharging is needed, a flow proceeds to step S920. When recharging is not needed, a flow proceeds to step S921. In step S920, recharging of the battery power is started. In step S921, a camera control processing is finished by putting camera phone 101 and an in-vehicle computer on standby.

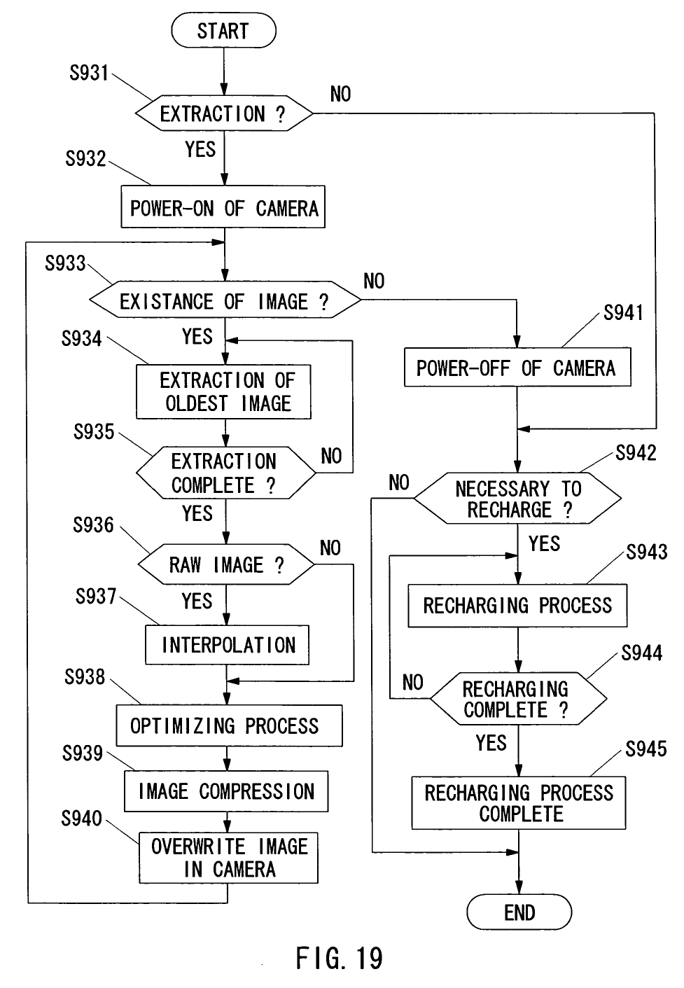

A control of extracting an image data of camera phone 101 to be executed by in-vehicle computer 201 will be explained herein after. FIG. 19 is a flowchart showing a control of an image data processing to be executed in in-vehicle computer 201. This flow will be started by detecting arrangement of camera phone 101 in cradle 102 connected to in-vehicle computer 201.

In step S931, it is detected whether or not an operation button provided in cradle 102 to initiate extraction of an image data is operated. In a case of detection, a flow proceeds to step S932 and in a case of non-detection, a flow proceeds to step S942. In step S932, application of a current to a circuit necessary to control camera phone 101 is instructed.

In step S933, it is detected whether or not there is an image data within camera phone 101 larger than a given size. Herein, an image data larger than a given size refers to a RAW image data etc, not an image data for reproduction that is created to view on a monitor of camera phone 101. When there is the image data larger than the given size, a flow proceeds to step S934 and when there is not the image data larger than the given size, a flow proceeds to step S941. In step S934, the image data larger than the given size existing within camera phone 101 is extracted. Along with the image data, a storage condition data etc is extracted too. The storage condition data is a data that includes an image size, a compression ratio and a storage location etc at storage of the image data. The extraction is performed from an older image data in terms of a shooting day and time.

In step S935, it is detected whether or not extraction of the image data is complete. When the extraction thereof is complete, a flow proceeds to step S936, but when the extraction thereof is not complete, a flow gets back to step S934 where the extraction thereof is continued. In step S936, it is judged whether or not the extracted image data is a RAW data and when the extracted image data is a RAW data, a flow proceeds to step S937. But when the extracted image data is not a RAW data, a flow proceeds to step S938. In step S937, a pixel interpolation processing etc is performed on the extracted RAW image data to let the extracted RAW image data be capable of being reproduced.

In step S939, a compression processing etc is performed on the image data in accordance with the storage condition data. In step S940, to replace a pre-processed image data existing within camera phone 101 with an image data processed in in-vehicle computer 201, the processed image data is sent out to camera phone 101 where the processed image data is stored by overwriting the pre-processed image data. Getting back to step S933, a control from steps S934 to S940 is repeated when there is an image data other than the processed image data.

In step S941, a power of camera phone 101 is turned off. In step S942, it is detected whether or not it is necessary to recharge a battery power of camera phone 101. When recharging is needed, a flow proceeds to step S943, but when recharging is not needed, this flow is finished. In step S943, recharging is executed. In step S944, it is detected whether or not recharging is complete. When the recharging is complete, a flow proceeds to step S945, but when the recharging is not complete, a flow gets back to step S943 where the recharging is continued. In step S945, the recharging is finished.

Accordingly, with the control such that an image processing which camera phone 101 in itself cannot perform is executed in in-vehicle computer 201 and after the execution, the processed image data is returned to camera phone 101, an advanced image processing can be performed without imposing a burden on camera phone 101. And the foregoing control is realized only by a user's putting camera phone 101 in cradle 102 in place and execution of an operation button, so there is no burden to impose on the user. As the processed image data gets back to camera phone 101, the processed image data can be carried around with camera phone 101.

When a vehicle is stopped or there is a passenger, a lot of operations can be performed while viewing monitor 107 because nothing hinders driving. Then, in-vehicle computer 201 executes a different control according to a car stoppage state or a presence of a passenger. In the case of the car stop condition or the presence of a passenger, as driving is not hindered and an operation to order a print order of an extracted image data is operable, so the extracted image data is displayed on monitor 107 and an operation with respect to monitor 107 makes it possible to place a print order.

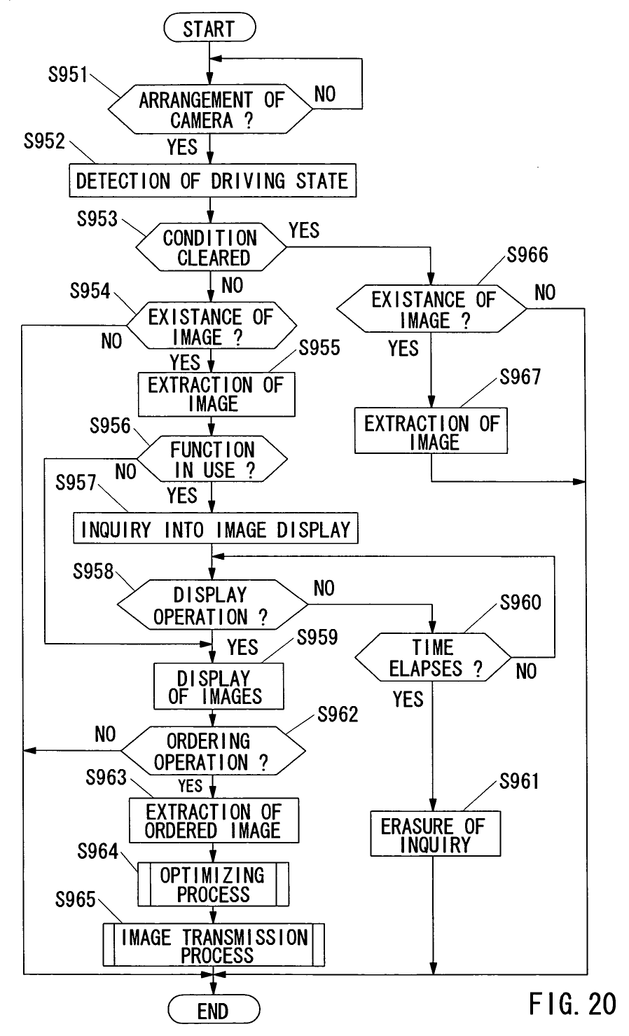

FIG. 20 is a flow chart showing a control to be executed in in-vehicle computer 201. In step S951, it is detected whether or not camera phone 101 is arranged in cradle 102. When the arrangement is detected, a flow proceeds to step S952, but when the arrangement is not detected, detection is continued. In step S952, a driving condition and a presence of a passenger are detected. In step S953, it is judged whether or not a given condition like a vehicle being stopped or there being a passenger is cleared. When the given condition is cleared, a flow proceeds to step S954, but when the condition is not cleared, a flow proceeds to step S966.

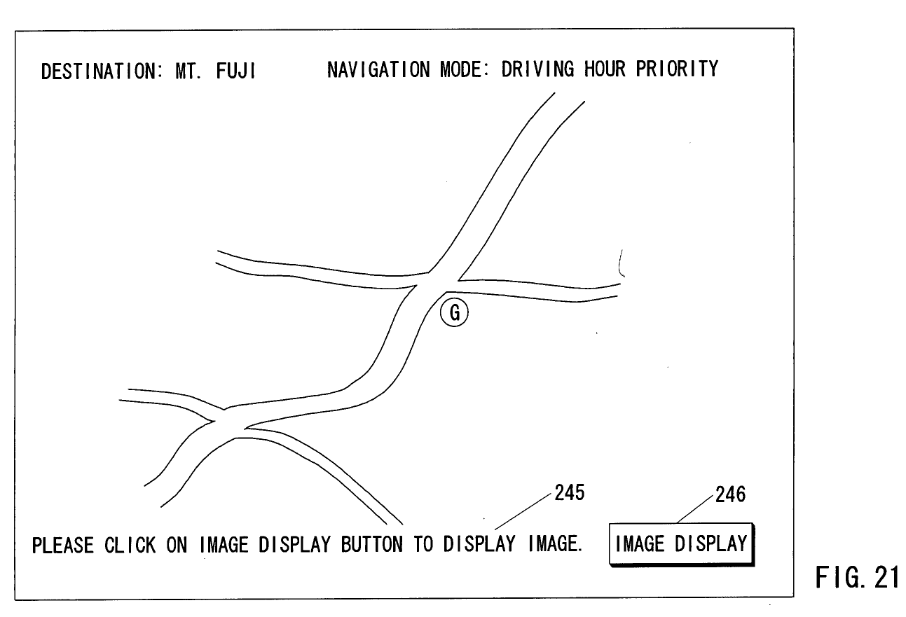

In step S954, it is detected whether or not there is an image data within camera phone 101 larger than a given size. When there is the mage, a flow proceeds to step S955, but when there is not the mage, this flow is finished. In step S955, extraction of the mage data is executed. In step S956, it is detected what any of functions available on monitor 107 is executed. Any of functions available on monitor 107 herein includes a setting of a driving route of a car navigation system, viewings of a TV broadcasting and a cinema and an Internet browsing and so. When any thereof is ON, a flow proceeds to step S957, but when any thereof is not executed, a flow proceeds to step S959. In step S957, a display asking if an image data is displayed is displayed on monitor 107 by overlapping a display of a function now under execution. In FIG. 21, an example of a screen display to be displayed on monitor 107 is shown. In the example of a screen display of FIG. 21, by overlapping a display of car navigation, text 245 asking if pluralities of the extracted image data are displayed and image display button 246 to instruct an image display appear. Click on image display button 246, and a display screen of the pluralities of the image data extracted from camera phone 101 can be switched over.

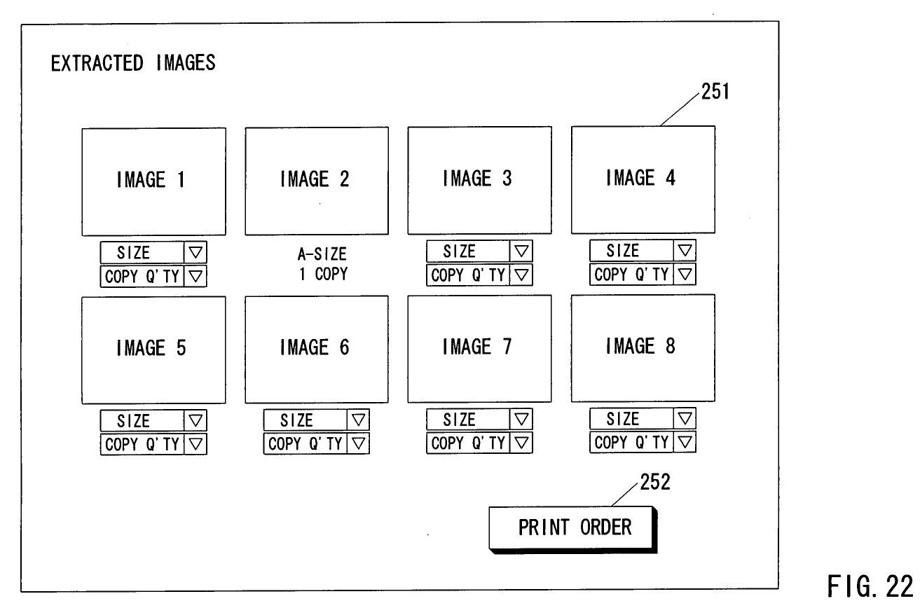

In step S958, it is detected whether or not image display button 246 is clicked on. When display button 246 is clicked on, a flow proceeds to step S959, but when display button 246 is not clicked on, a flow proceeds to step S960. In step S960, it is whether or not a given period of time has elapsed. When the given period of time has elapsed, a flow proceeds to step S961, but when the given period of time has not elapsed, a flow gets back to step S958. In step S961, a screen is changed over to a display in which text 245 and image display button 246 are erased and gotten rid of from the screen display of FIG. 21. In step S959, a display of monitor 107 is changed over to a screen that displays the pluralities of the extracted image data. An example of a display screen is shown in FIG. 22. A print order such as a print size and the number of the print hard copies can be instructed every image. FIG. 22 shows that a user has already instructed the print size and the number a hard copy print with respect to image 2. With an operation of print order button 252, a print order is placed with print server 31. The pluralities of the image data are displayed in order of an older shooting day/time image data.

In step S962, it is detected whether or not print order button 252 is operated. When the button is operated, a flow proceeds to step S963, but when the button is not operated, this flow is finished. In step S963, an image data relevant to the print order is extracted. In step S964, the foregoing optimizing processing is performed on the extracted image data. When the extracted image data is a RAW image data, a processing like the pixel interpolation etc is also performed. In step S965, the image data performed by the optimizing processing is sent out to print server 31. In step S966, it is detected whether or not there is the image data. When there is the image data, a flow proceeds to step S967, but when there is not the image data, this flow is finished. In step S967, extraction of the image data is executed.

Such the control as explained above is configured such that for a safety sake, an operation can be executed only when a vehicle is stopped or there is a passenger and the like, but when a safe-proof ability ensuring a driving safety is provided in a vehicle, the operation may be executed at any time even if the foregoing condition is not cleared.

Even when the condition is cleared, it can be said that a user's intention about a display of an image data and a print order is unclear. When car navigation or any of other functions in use is displayed on a monitor, a screen of car navigation in use is prioritized without changing over from a going screen of monitor 107 to a display of an image data. Naturally, the car navigation screen is prioritized over processing to be executed in in-vehicle computer 201 other than the display of the image data. Also, even if the condition is not cleared, let a control of image extraction that does not need a user's operation or a display on monitor 107 be executed. In the foregoing control, the pixel interpolation processing and the optimizing processing are performed with respect to only the image data that is on print order and is going to be sent out to print server 301. As the processing is performed at a time of using the image data, the optimizing processing is not performed on other image data rather than the image data on print order, so that there is no wasteful processing on the other image data, for instance, a turkey of a picture that does not need the optimizing processing. Further, when other image data rather than the image data on print order this time will be used in the future, the optimizing program can be also version-updated to realize a more optimizing.

In a control to be executed in in-vehicle computer 201 to be explained hereinafter, the pixel interpolation and the image optimizing processing will be performed on an image data not on print order. An image data on print order is sent out to print server 301 intact. That is, the image data that is sent out to print server 301 is performed in print server 301 by a pixel interpolation processing and an image optimizing processing whereas the image data that is not sent out to print server 301 is performed in in-vehicle computer by the pixel interpolation processing and the image optimizing processing. The image data performed in print server 301 and in-vehicle computer 201 by the image optimizing processing are sent out to a single image storage server, where the image data are so stored therein as to be in an integrated way.

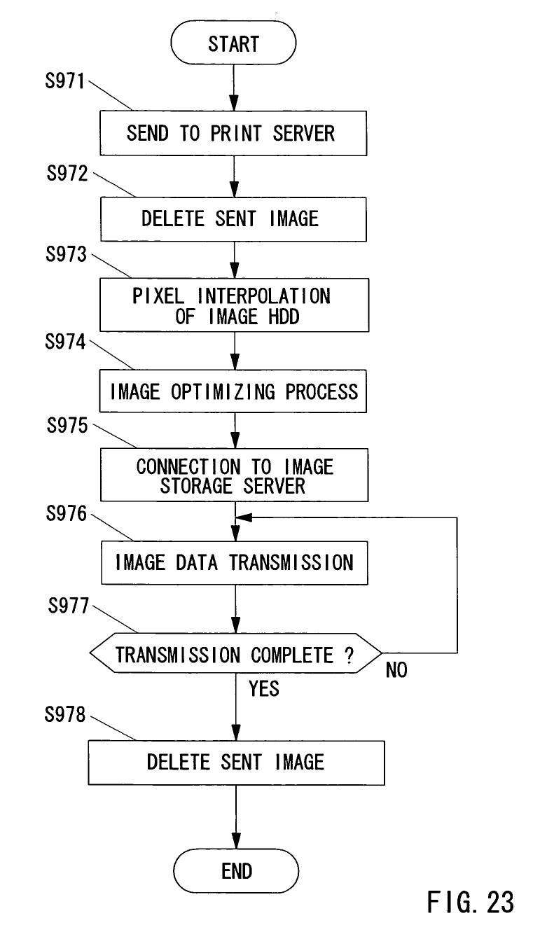

FIG. 23 is a flow chart showing a control to be executed in in-vehicle computer 201. This flow will be started by detecting a print order instruction of a user. Instep S971, an image data on print order is sent out to print server 301 in a RAW image data intact. The image data sent out to print server 301 is performed in print server 301 by the pixel interpolation processing and the image optimizing processing, printed out therein and then is transmitted to a given image storage server wherein the image data is stored therein. In step s972, the image data sent out to print server 301 is deleted from HDD 105. In step S973, the pixel interpolation processing is performed with respect to an image data left in HDD 105, namely, an image data that is not on print order. In step S974, the image optimizing processing is further performed on the image data that was performed by the pixel interpolation processing. In step S975, a given image storage server is connected. The given image storage server is the same server as print server 301 sends out an image data. In step S976, the processed image data is sent out to the given image storage server. In step S977, it is detected whether or not transmission of the image data to the given image storage server is complete. When the transmission thereto is complete, a flow proceeds to step S978, but when the transmission thereto is not complete, a flow gets back to step S976. In step 978, the image data of which the transmission to the given image storage server is complete is deleted from HDD 105.

In the embodiment as described above, for a control of an image data in an integrated way, the processed image data is sent out to the given image storage server in which the image data on print order is stored and is stored therein, but the processed image data may be stored in HDD 105, not in an image storage server. Other function priority control over extraction of an image data within camera phone 101 and a display thereof will be explained. When other function is being executed, the other function is prioritized even if extraction of an image is executed. When other function is executed while extracting an image data, execution of the other function is prioritized suspending the control of extraction of the image.

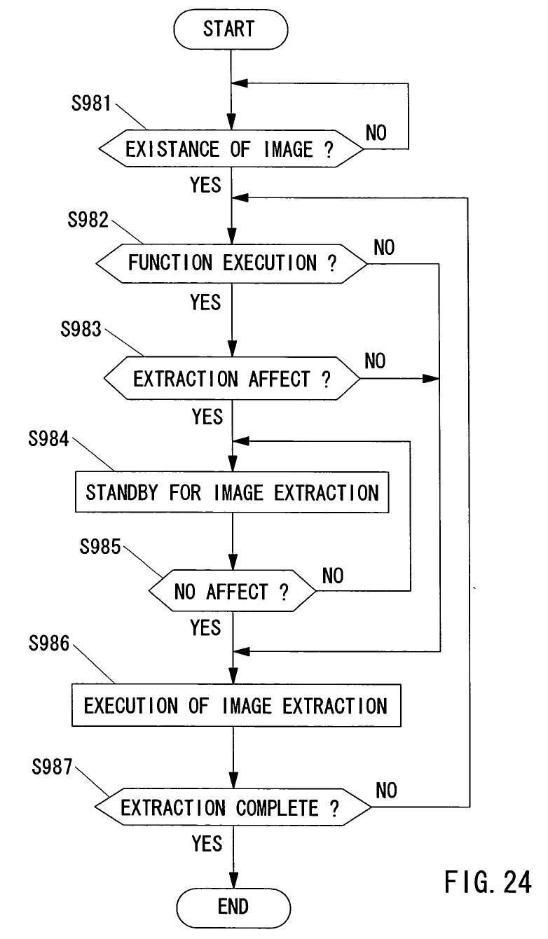

FIG. 24 is a flow chart showing a control to be executed in in-vehicle computer 201. This flow will be started by detecting an arrangement of camera phone 101 in cradle 102. In step S981, it is detected whether or not there is an image data within camera phone 101. When there is the image data therein, a flow proceeds to step S982, but when there is not the image data therein, this flow is finished. In step S982, it is detected whether or not other function like car navigation etc is being executed. When the other function is being executed, a flow proceeds to step S983, but when the other function is not being executed, a flow proceeds to step S986. In step S983, it is detected whether or not extraction of an image data affects the function. When extraction thereof affects, a flow proceeds to step S984, but when extraction thereof does not affect, a flow proceeds to step S986. In step S984, the function stands by a process of extracting an image data. In step S985, it is detected whether or not the executed function is not affected. When the executed function is not affected, a flow proceeds to step S986, but when the executed function is affected, a flow gets back to step S984 wherein the function stands by the process of extracting an image data.

In step S986, the process of extracting an image data is executed. In step S987, it is detected whether or not the extraction processing is finished. When the extraction processing is finished, this flow is finished, but when the extraction processing is not finished, a flow gets back to step S982.

With such the control, the process of extracting an image data never affects the execution of other functions. Other control to be executed in in-vehicle computer 201 will be explained. When in-vehicle computer 201 is in car navigation mode, reception of necessary map information is automatically started by arranging camera phone 101 in cradle 102. Naturally, information corresponding to a present positioning of a vehicle is received as map information. Only with an arrangement of camera phone 101 in cradle 102, camera phone 101 is connected to speaker 109 and microphone 108 disposed in a vehicle and a hand-free talking therein becomes possible. Camera phone 101 is enabled to function as a TV phone with the use of monitor 107. On the other hand, if data volume is large, a communication cost gets increased and navigation function and other functions might be affected. In a case where a communication function of camera phone 101 is used, a priority order of image transmission is put at the lowest in rank. Naturally, when other communication is needed during an image data transmission, the image data transmission is temporarily suspended. And, when a communication is executed using a wireless LAN within a hotspot area, not using the communication function of camera phone 101, the priority order of transmission of an image data is also set to the lower rank as compared with sending/receiving of a map data etc.

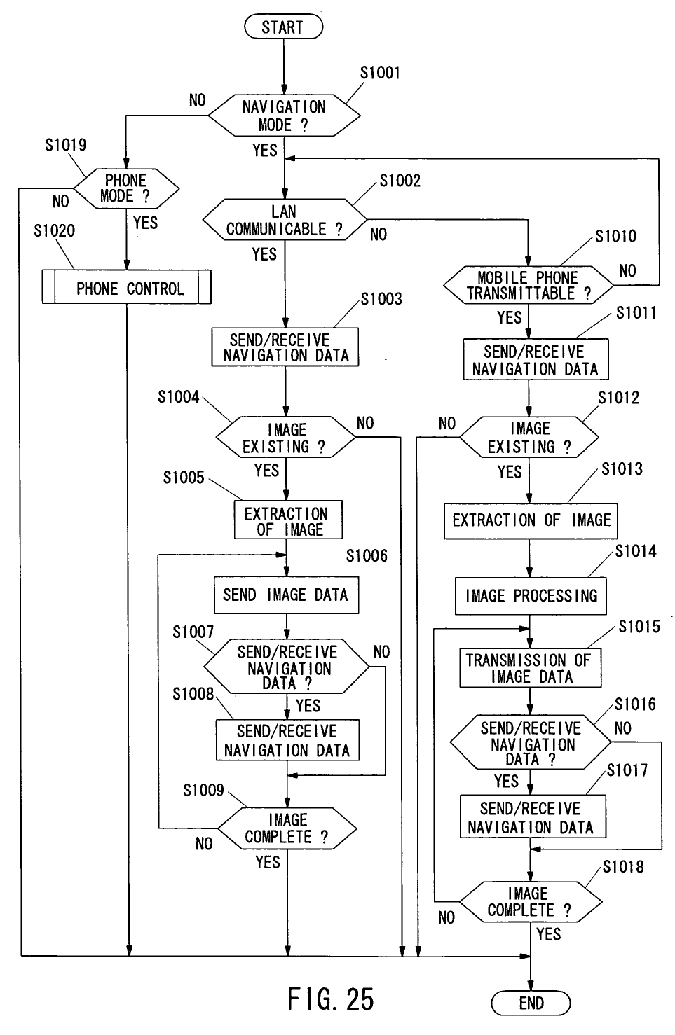

A control to be executed in in-vehicle computer 201 will be explained hereinafter. FIG. 25 is a flow chart showing a control to be executed in in-vehicle 201. This flow will be started by arranging camera phone 101 in cradle 102 and connecting camera phone 101 to in-vehicle computer 201.

In step S1001, it is detected whether or not a mode executed in in-vehicle computer 201 is a car navigation mode. When the mode is the car navigation mode, a flow proceeds to step S1002, but when the mode is not the car navigation mode, a flow proceeds to step S1013. In step S1002, it is detected whether or not a driven vehicle positioning is within an area of a hotspot and a wireless LAN communication is communicable. When the wireless LAN communication is communicable, a flow proceeds to step S1003, but when the wireless LAN communication is not communicable, a flow proceeds to step S1010. In step S1003, data to obtain a map data and a guide data and the like necessary for car navigation is sent/received. In step S1004, it is detected whether or not there is an image data within camera phone 101 to be sent out to an external computer. When here is the image data therein, a flow proceeds to step S1005, but when there is not the image data therein, this flow is finished. In step s1005, the image data within camera phone 101 is extracted. In step S1006, the image data extracted via the wireless LAN is sent out to an external computer. In step S1007, it is detected whether or not there is the data sent/received to obtain a map data and a guide data and the like necessary for car navigation. When there is the data, a flow proceeds to step S1008, but when there is not the data, a flow proceeds to step S1009. In step S1008, the data for car navigation is sent/received by halting transmission of the image data temporarily. In step S1009, it is detected whether or not transmission of the image data is complete. When the transmission is complete, this flow is finished, but when the transmission is not complete, a flow gets back to step S1006 wherein the transmission of the image data is continued.

In step S1010, it is detected whether or not a communication using the communication function of camera phone 101 is communicable. Nowadays, a cell phone communicable area is absolutely broader than a wireless LAN communicable area. When the communication is communicable, a flow proceeds to step S1011, but when the communication is not communicable, a flow gets back to step S1002 and detection is continued until any of the wireless LAN communication or the cell phone communication becomes communicable. In step S1011, the map data and the guide data and the like necessary for car navigation are received. In step S1012, it is detected whether or not there is an image data within camera phone 101 to be sent out to an external computer. When there is the image data therein, a flow proceeds to step S1013, but when there is not the image data therein, this flow is finished. In step S1013, the image data within camera phone 101 is extracted.

In step S1014, image processing as described in steps S910 to S913 of FIG. 18 are performed with respect to the extracted image data. A processing of reducing data volume with compression of an image helps decrease a communication cost by a cell phone of a slower communication speed than that of a wireless LAN. In step S1015, the processed image data is sent out to the external computer via a communication network of camera phone 101. In step S1016, it is detected whether or not there is the data sent/received to obtain the map data and the guide data necessary for car navigation. When there is the data, a flow proceeds to step S1017, but when there is not the data, a flow proceeds to step S1018. In step S1017, the data for car navigation is sent/received by halting transmission of the image data temporarily. In step S1018, it is detected whether or not transmission of the image data is complete. When the transmission is complete, this flow is finished, but when the transmission is not complete, a flow gets back to step S1015 wherein the transmission of the image data is continued. In step S1019, it is detected whether or not a mode executed in in-vehicle computer 201 is a telephone mode. When the mode is the telephone mode, a flow proceeds to step S1020, but when the mode is not the telephone mode, this flow is finished. In step S1020, a telephone control to be explained hereinafter is executed.

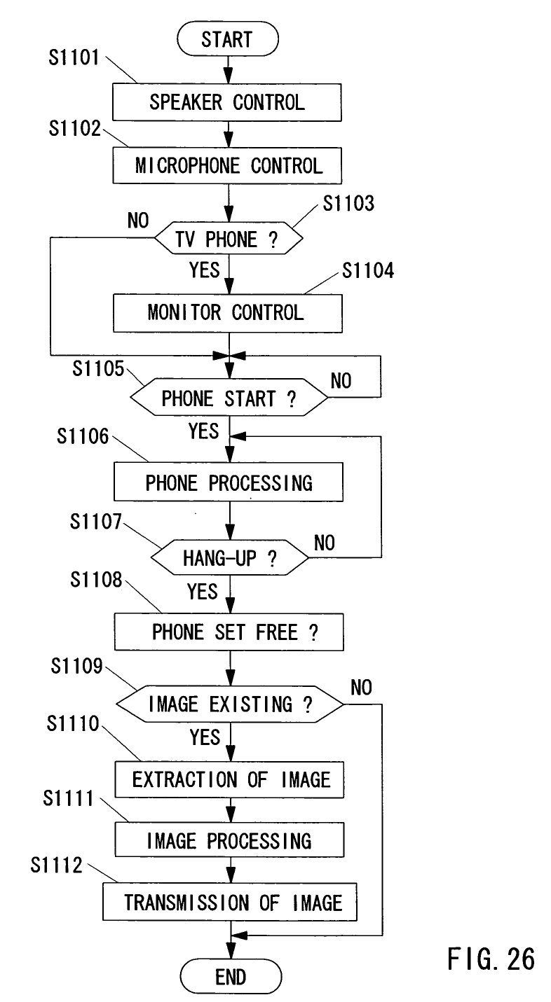

With such the control, as sending/receiving of the data for car navigation is prioritized over the transmission of the image data, any problem does not occur in car navigation. Execution of the wireless LAN communication prior over the communication function of camera phone 101 helps realize reductions in a communication time and communication cost. A telephone control to be executed in step S1020 of FIG. 25 will be explained. FIG. 26 is a flow chart showing a telephone function to be executed in in-vehicle communication 201.

In step S1101, speaker 109 enables a received caller's voice to be reproduced. In step S1102, microphone 108 enables a voice picked up by microphone 108 to be transmitted to the caller. In step S1103, it is detected whether or not a telephone of the caller transmits an image data with a TV phone. When the telephone thereof is the TV phone, a flow proceeds to step S1104, but when the telephone thereof is not the TV phone, a flow proceeds to step S1106. In step S1104, an image data of the caller is made available for display by turning monitor 107 on. In step S1105, it is detected whether or not a call is started. When the call is started, a flow proceeds to step S1106, but when the call is not started, detection is continued. In step S1106, a state of being capable of calling of speaker 109 etc is kept. Instep S1107, it is detected whether or not the call is finished. When the call is finished, a flow proceeds to step S1108, but when the call is not finished, a flow gets back to step S1106. In step s1108, the state of speaker 109 etc being capable of calling is set free. In step s1109, it is detected whether or not there is an image data within camera phone 101 to be sent out to an external computer. When there is the image data therein, a flow proceeds to step S1110, but when there is not the image data therein, this flow is finished. In step S1110, the image data to be sent out to the external computer is extracted. In step S1111, an image processing is performed -on the extracted image data. In step S1112, the processed image data is sent out to the external computer.

With such the control, just arrangement of camera phone 101 in cradle 102 enables speaker 109, microphone 108 and monitor 107 installed in a vehicle to be automatically used for calling and a phone call can be made with a hand-free. Further, other control to be executed in in-vehicle computer 201 will be explained. A hotspot and its communicable area are displayed using positioning information of a navigation system. There is the prior art in which an inside or an outside of a hotspot is displayed. However, when a driven vehicle is outside the area, it is hard to see in which direction to drive the vehicle in order to get inside the area. Contrary to this, this system enables a user to get to see a hotspot area even when the user is outside the area, so there is no need for searching for the hotspot with a shotgun approach. For instance, when the user takes a rest, the user can easily take a rest within the hotspot area and also communicate therein. Only when data like an image data taken with camera phone 101 is so set as to be sent out externally, the hotspot area is caused to be automatically brought up.

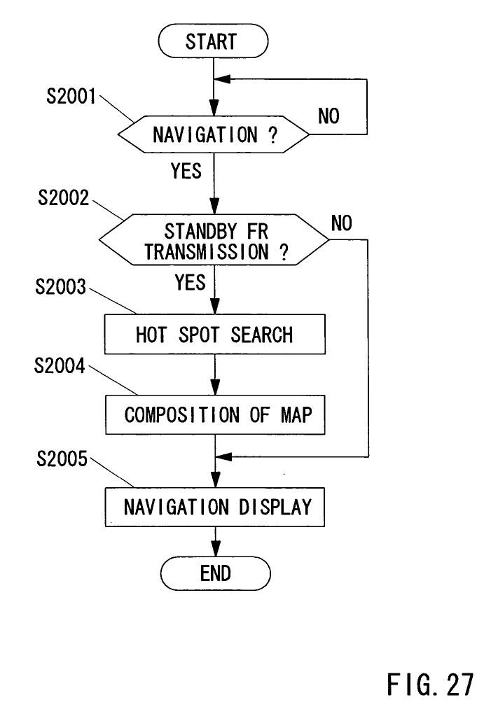

A setting device that sets up a display or a non-display of the hot spot area may be provided. When a communication data is not on standby, as a display screen of the hotspot area overlapping over a map screen looks unpleasant, the hotspot area is not displayed. FIG. 27 is a flow chart showing a control to be executed in in-vehicle computer 201.

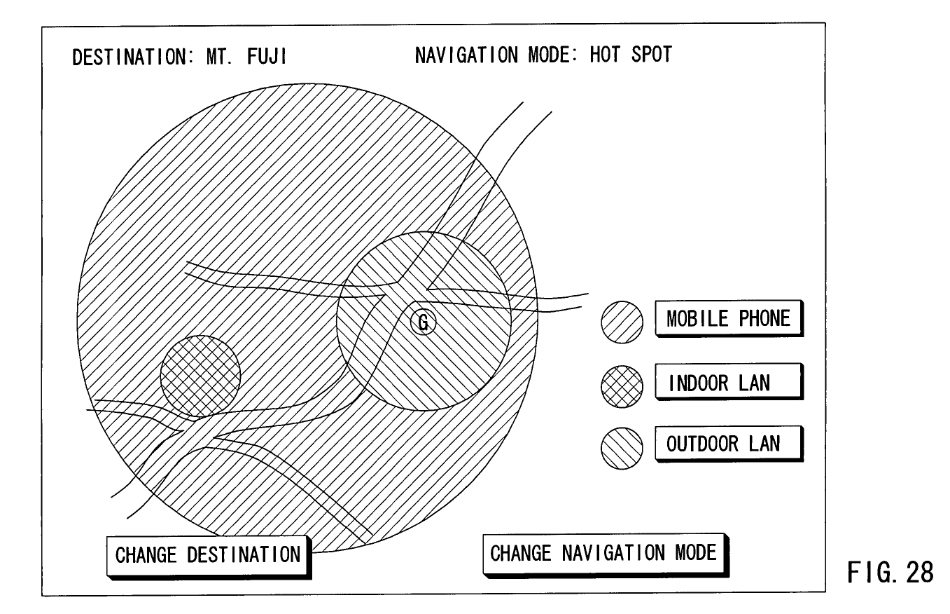

In step S2001, it is detected whether or not a mode is set to a navigation mode. When the mode is set to the navigation mode, a flow proceeds to step S2002, but when the mode is set to other than the navigation mode, detection is continued in step S2001. In step S2002, it is detected whether or not there is data on standby for a communication. When there is the data, a flow proceeds to step S2003, but when there is not the data, a flow proceeds to step S2005. In step S2003, registered hotspot information is searched. In step S2004, map information for navigation is composed with searched hotspot information. In step S2005, a navigation screen is displayed on monitor 107 as shown in FIG. 28. Naturally, the navigation screen is colored/displayed such that a hotspot area where an in-vehicle computer is usable while driving can be differentiated from a hotspot area where a portable hand-held apparatus is brought inside a room and usable therein. And, by selecting an indoor hotspot or an outdoor hotspot, only either of the indoor or outdoor hotspot may be so set as to be displayed. Also, a call area of a cell phone is displayed too.

In-vehicle computer 201 is provided with a hotspot mode that preferentially works out a driving route passing through a hotspot as navigation abilities. The hotspot mode is selected when data like an image data etc is to be sent out while driving. When plural routes are worked out, information on a hotspot is displayed per each route in conjunction with a driving mileage and an expected driving time to a destination. Then, a user can select a route.

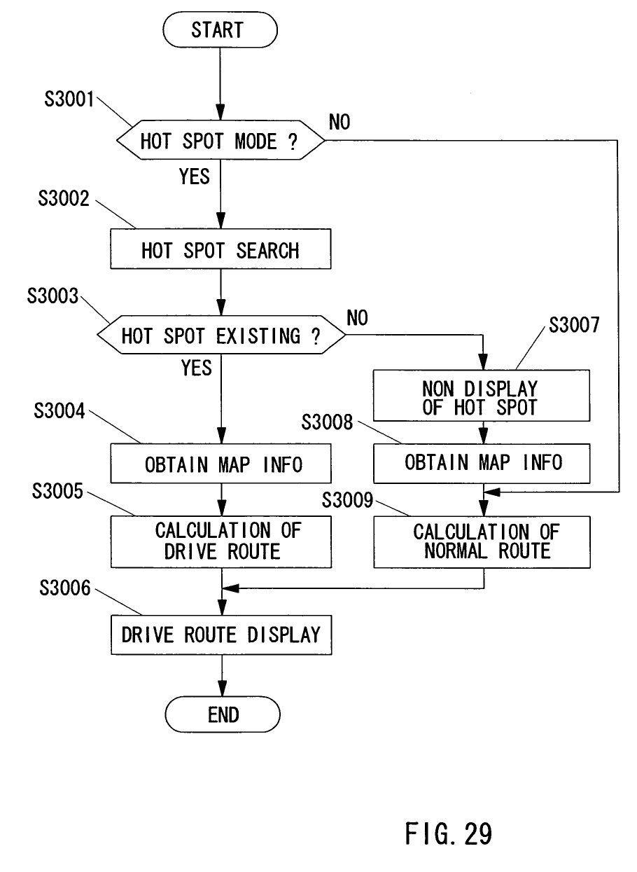

Also, a hotspot where to stop over is first predetermined and then a route may be worked out. FIG. 29 is a flow chart showing a control of working out a driving route to be executed in in-vehicle computer 201.

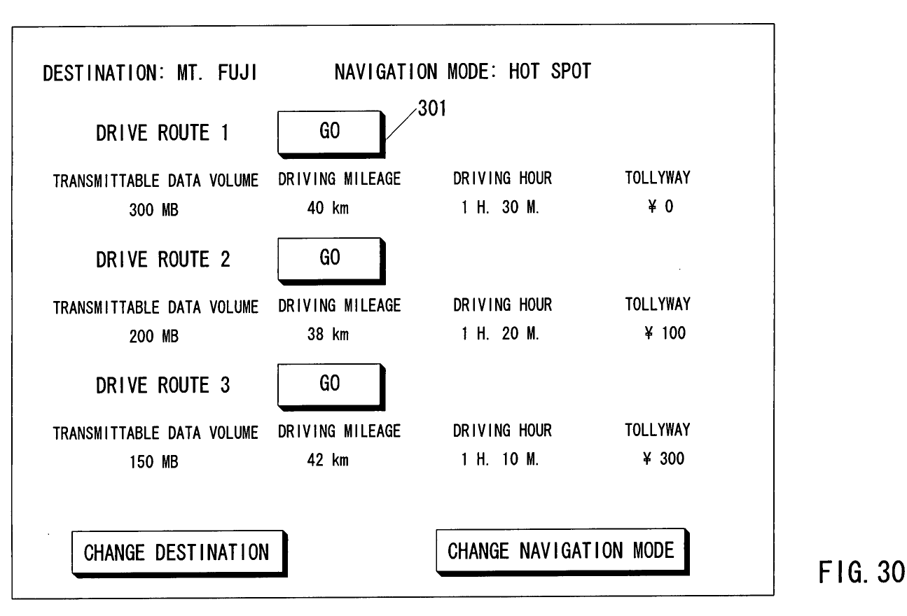

In step S3001, it is detected whether or not a hotspot mode is set. When the mode is set, a flow proceeds to step S3002, but when the mode is not set, a flow proceeds to step S3008. In step S3002, a hotspot database is searched. In step S3003, it is detected whether or not there is a hotspot within plural driving routes directed for a set destination. When there is the hotspot therein, a flow proceeds to step S3004, but when there is not the hotspot therein, a flow proceeds to step S3007. In step S3004, map information is obtained. In step S3005, a driving route is worked out from the map information and the hotspot information. In step s3006, information on a worked out route is displayed. FIG. 30 is a display example showing driving route information in the hotspot mode. In FIG. 30, the driving route is displayed in a transmittable large data volume order with respect to a typed destination. For example, route 1 shows that an expected transmittable data volume up to the destination is estimated to be 300 MB, an expected driving mileage thereto is estimated to be 40 Km,an expected driving time thereto is estimated to be 1 hour 30 minutes and a toll way tariff thereto is estimated to be zero. As the transmittable data volume varies with a driving speed at passing through a hotspot, the data volume is just only the data volume as an expectation. Clicking on selection button 301, and a driving route is determined. And, when changing a destination, change destination button 302 is clicked on. When changing the mode to a driving mileage priority mode and a driving time other than the hotspot mode, navigation mode change button 303 is clicked on. Also, monitor 107 is composed of a touch panel in which a button displayed thereon can be directly operated.

On the other hand, in step S3007, a display indicating that there is no driving route passing through the hotspot up to a destination is performed. In step S3007, map information is obtained. In step S3008, a driving route in which a vehicle can arrive at a destination in the shortest time like a normal navigation mode is displayed. With such the control, a driving route in favor of passing through a hotspot area can be selected and thus this system becomes very convenient when there is data to be sent out while driving.

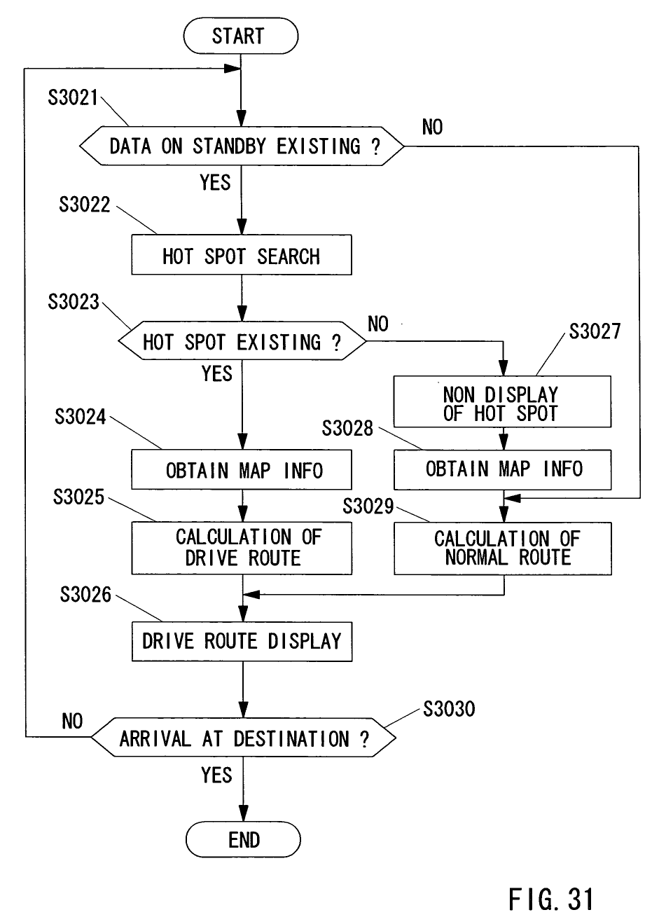

A control to be explained below will automatically work out driving routes so as to pass through as many hotspot areas as possible when there is data to be sent out to an external computer etc and the data is on standby for transmission. A control to be executed in in-vehicle computer 201 will be explained. FIG. 31 is a flow chart showing a control to be executed in in-vehicle computer 201. In step S3021, it is detected whether or not there is data such as an image data on standby for transmission. When there is the data, a flow proceeds to step S3022, but when there is not the data, a flow proceeds to step S3028. In step S3022, a hotspot database is searched. In step S3023, it is detected whether or not there is a hotspot within plural driving routes directed for a set destination. When there is the hotspot, a flow proceeds to step S3024, but when there is not the hotspot, a flow proceeds to step S3027. In step S3024, map information is obtained. In step S3025, a driving route is worked out from the map information and the hotspot information. In step S3026, a navigation screen equivalent of the display example shown in FIG. 28 is displayed.

In the meanwhile, in step S3027, a display indicating that there is no driving route passing trough a hotspot up to the destination is displayed. In step S3027, map information is obtained. In step S3028, a reachable driving route in the shortest time like a normal navigation mode is displayed. Instep S3030, it is detected whether or not a user driven vehicle reaches the destination. When the vehicle reaches, this flow is finished. When the vehicle does not reach, a flow gets back to step S3021. Namely, this control will be continued until the vehicle reaches the destination. Accordingly, when the vehicle is off the driving route, existence of a hotspot is checked again and a new driving route is searched. Also, for example, when an image data taken while driving is newly on standby for transmission, a driving route can be changed over from a normal driving route to a driving route in favor of a hotspot.

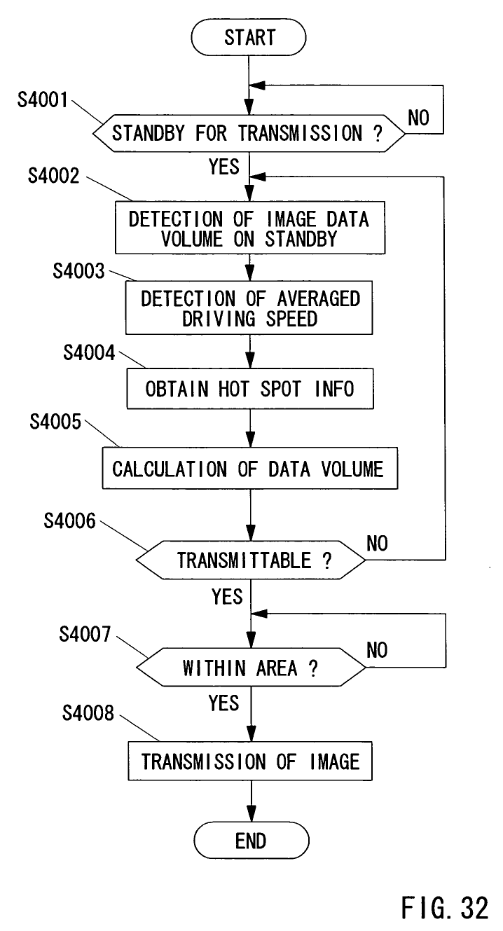

A communication control of a data to be executed in in-vehicle computer 201 will be explained. Although a communication area of a cell phone is communicable in an extensive area, there are problems in a transmission speed and a cost of communication. Thus, transmission of an image data taken with a camera is controlled so as to stand by until a vehicle enters into a hotspot. Also, it is judged whether or not the image data is sent out in responding to a driving speed. As a high-speed driven vehicle might deviate from the wireless LAN spot while transmitting an image data, transmission is determined based upon data volume to be sent and a driving speed. FIG. 32 is a flow chart showing a communication control to be executed in in-vehicle computer 201.

In step S4001, it is detected whether or not transmission is on standby. Transmission on standby is a state of transmission of data being put on standby such that data like an image data etc will be automatically sent out externally when transmission becomes available. When transmission is on standby, a flow proceeds to step S4002, but when transmission is not on standby, a flow stays in step S4001 where detection of transmission becoming on standby is continued. In step S4002, volume of the data being on standby for transmission is obtained. In step S4003, averaged driving speed information in the latest 10 minutes is obtained. In step S4004, information on a next passing hotspot along a driving route by navigation is obtained. In step s4005, data volume of the image data being on standby for transmission is calculated when passing through a next hotspot. In step s4006, it is judged whether or not the calculated data volume is transmittable. When the data volume is judged to be transmittable, a flow proceeds to step S4007, but when the calculated data volume is judged not to be transmittable, a flow gets back to step S4002.

In step s4007, it is detected whether or not the data becomes transmittable. When the data is transmittable, a flow proceeds to step S4008, but when the data is not transmittable, detection is continued. In step S4008, the data on standby is sent out to an external receiver such as a server computer etc.

With such the control, in-vehicle computer 201 can send out to an external computer an image data automatically extracted from camera phone 101 when a vehicle enters in a hotspot area provided at a gas station etc so that there is no need to take a trouble to operate transmission every time a hotspot area comes in. And, with such the control, a transmission failure like data transmission fails while transmitting can be avoided. Also, all of the image data is not transmitted at a time, but the image data to be transmitted may be delivered in divided data. And, although transmittable data volume is calculated using the averaged driving speed, the transmittable data volume may be calculated using a going driving speed, not the averaged speed. Also, an averaged driving speed may not be with reference to the latest 10 minutes. Imaged at a transmission may be performed only when a vehicle is stopped (driving speed is 0 Km/h).

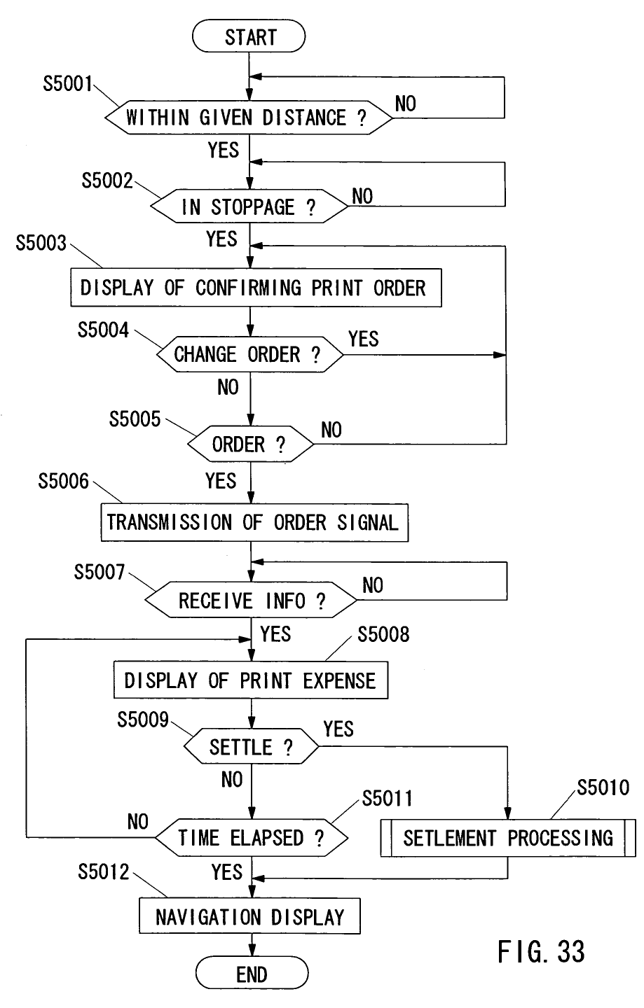

A control to be explained hereinafter permits to receive a hard copy of a print-ordered image data when a rental vehicle was returned. A control to be executed in in-vehicle computer 201 will be explained. FIG. 33 is a flowchart showing a control to be executed in in-vehicle computer 201.

In step S5001, it is detected using abilities of GPS sensor 111 whether or not a distance up to a return depot of a rental vehicle becomes within a given distance. In-vehicle computer 201 judges that a location selected as a destination of navigation is a return depot of a rental vehicle when a service depot of a rental vehicle is selected as the destination of navigation. For example, assume that the given distance herein is 10 Km. When a distance is within the given distance, a flow proceeds to step S5002, but when the distance is not within the given distance, judgment is continued. In step S5002, it is detected whether or not a rental vehicle is stopped. When the car is stopped, a flow proceeds to step S5003, but when the car is not stopped, detection is continued. The reason of this is that a display of monitor 107 is caused to be changed to a screen of a print order only when the car is stopped in order to let a driver concentrate on driving.

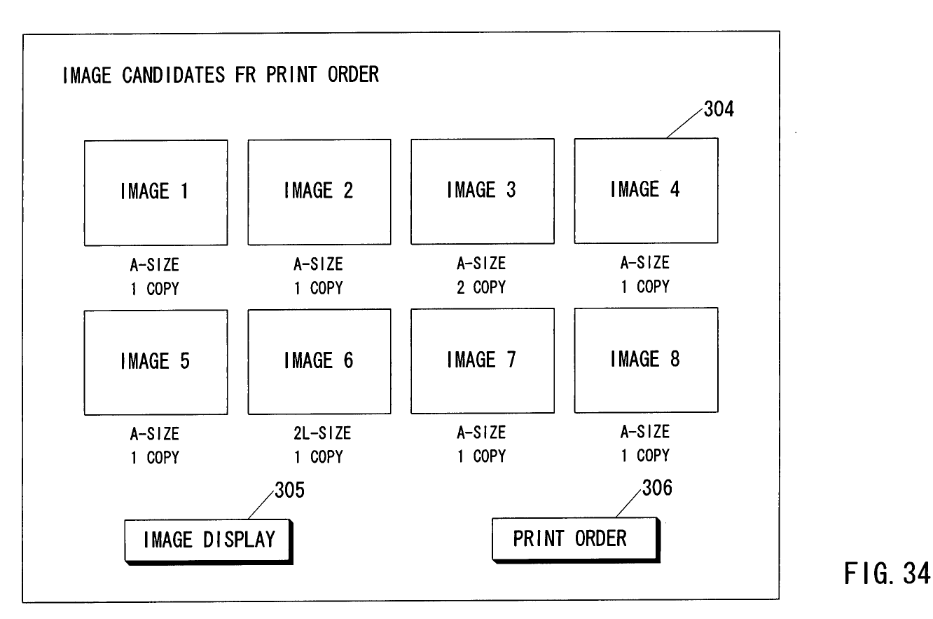

In step S5003, a display of monitor 107 is changed from a navigation display to a display of image candidates on print order in in-vehicle computer 201. FIG. 34 shows an example of a display of the image candidates on print order. In FIG. 34, each reduced image 304 of image data on print order is displayed. A print size and a quantity of a print hard copy on print order are displayed below each reduced image 304. For example, image 1 has one piece of a hard copy with a sample size on order. A change to a print order is to be operated on this screen. When a print order is changed, image display button 305 is to be operated. Operate image display button 305 and a screen of displaying all the transmitted image data is brought up and then an addition or a change to a print order can be implemented thereon. And when contents of the image candidates on print order are OK, click on print order button 306. Clicking on print order button 306 finally places a print order with a laboratory that makes a hard copy of the image and the print thereof is started at a print laboratory etc.

In step S5004, it is checked whether or not there is any change in the print order via the operation of image display button 305. When there is a change, a flow gets back to step S5003 and in accordance with the changed content, the display of the image candidates on print order is brought up again. When there is no change, a flow proceeds to step S5005. In step S5005, it is checked whether or not print order button 306 is operated. When button 306 is operated, a flow proceeds to step S5006, but when button 306 is not operated, checking is continued. In step S5006, an order signal is sent out to print server 301. Information on the return depot set as the destination of navigation is sent out to print server 301 too. The order signal and the information on the return depot are directly sent out to print server 301, but like the first embodiment, they may be transmitted to print server 301 via the certificate server.

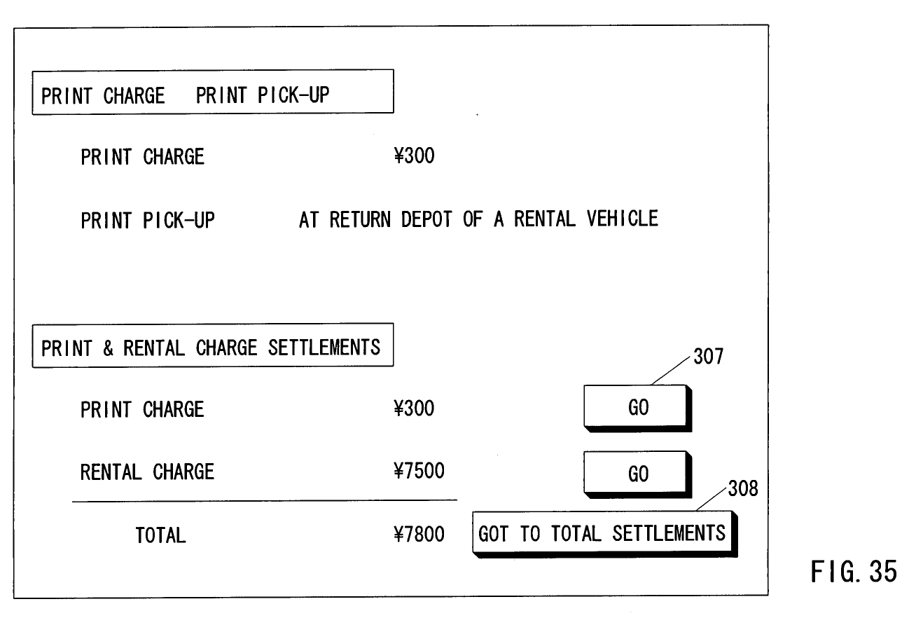

In step S5007, it is detected whether or not confirmation information about a pick-up location and print charge information that print server 301 sends out in response to the order signal are received. When these information are received, a flow proceeds to step S5008, but when these information are not received, detection is continued. In step S5008, a display of monitor 107 is changed to a display showing the print charge and the pick-up location of the print copies as shown in FIG. 35. FIG. 35 shows that the print charge is ¥300 and the pick-up location is the return depot of the rental vehicle and settlement of the print charge and the rental vehicle charge is also displayed therein. On an example display screen of FIG. 35, the settlement of the print charge and the rental vehicle is also inquired into thereon. Clicking on settlement button 307 permits the print charge or the rental vehicle charge to be settled respectively. Also, clicking on combined settlement button 308 can settle both of the print charge and the rental vehicle charge at a time.

In step S5009, it is checked whether settlement button 307 or combined settlement 308 is operated. When any of the settlement buttons is operated, a flow proceeds to step S5010, but when any of the settlement buttons is not operated, a flow proceeds to step S5011. In step S5010, a settlement processing is executed using a settlement system of a connected cell phone. In step S5011, it is judged whether or not a given period of time (e.g. one minute) has elapsed since the display of FIG. 35 appears. When the period of time has elapsed, a flow proceeds to step S5012, but when the period of time has not elapsed, the display of FIG. 35 is continued. In step S5012, a display of monitor 107 is changed to a navigation display.

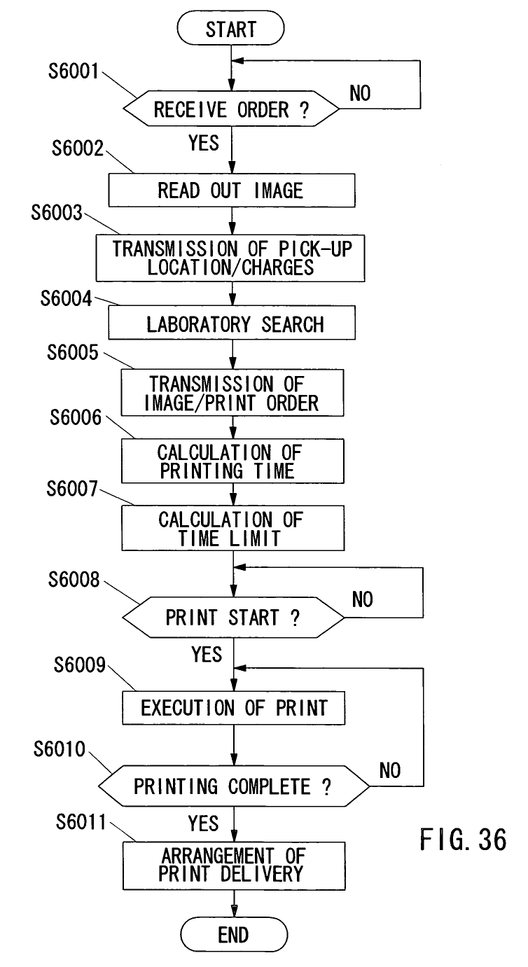

A control to be executed in print server 301 where the print is ordered will be explained. FIG. 36 is a flow chart showing a control to be executed in print server 301. In step S6001, it is detected whether or not print order information, return depot information and expected return time information are received. As an expected return time, an expected destination arrival time calculated by car navigation abilities is used. When the foregoing information is received, a flow proceeds to step S6002, but when the information is not received, detection of reception is continued. In step S6002, an image data on print order is read out. In step S6003, information about pick-up location, which is a return depot of the rental vehicle, and the print charge information are sent out to in-vehicle computer 201.

In step S6004, a print laboratory close to the rental vehicle return depot is searched for. In step s6005, an image data and print order information are sent out to a computer of the print laboratory close to the return depot obtained through the search. In step S6006, an expected printing time from a print start to a print finish is calculated. In step s6007, a time limit for the print start considering a delivery time to the return depot of the rental vehicle is calculated from the expected return time of the rental vehicle. In step S6008, it is judged whether or not the print is immediately started as compared with other print order information. When the print is immediately started, a flow proceeds to step S6009, but when the print is put on standby, judgment about the print start is continued.

In step S6009, the print of the image data on print order is executed. In step S6010, it is detected whether or not the print is finished. When the print is finished, a flow proceeds to step S6011, but when the print is not finished, the print is continued. In step S6011, a print delivery to the return depot of the rental vehicle is arranged so as to meet a return time of the rental vehicle in use. Although such the control is executed by print server 301, the control may be executed by other server computer. The control may be executed by working with other server computer, not by a single print server.

Such the control can save a time that it takes to calculate the print charge after a rental vehicle is returned to service station of the return, so the print charge can be easily settled. Also, the print charge and the rental vehicle charge can be settled using a camera phone, so no time is wastefully taken at the return depot. And, as a print out of the image data on print order has been already delivered to the return depot of the rental vehicle, the print out can be picked up without delay at returning the rental vehicle. Further, by confirming a final print order near the return depot of the rental vehicle and making the print, the print processing for the same user can be executed all together and there is no extra workload like sorting out of the finished prints. Also, an image on print order can be cancelled in a halfway, so no wasteful print out is created.

Further, as a last order of the print order is automatically called for, the print order is not forgotten. Since the print is started so as to meet the expected return time of the rental vehicle such that the print can be picked up at retuning the vehicle, there is no need for the user to wait for the delivery of the print at the return depot. The print laboratory close to the return depot of the rental vehicle (pick-up location of the print) is so controlled as to be automatically selected, so a delivery time loss is held down. A printer and a print server are disposed inside a service station of the return depot, wherein an image data is automatically sent out to the return depot and then the printer disposed inside the service station may make a print. A print laboratory and a rental vehicle shop may run a print shop jointly.

Such the control describes the example in which the return depot of the rental vehicle is automatically selected as the pick-up location and a delivery location. However, if the return depot of the rental vehicle is not included in a print delivery route of the print laboratory, an extra deliver cost might be accrued. Also, when the return depot and the print laboratory are apart from each other, it might be inconvenient. In these cases, a gas station, a convenience shop or a hotel along the driving route up to the return depot is so configured as to be automatically selected. Also, there is a case where a user is required to refill a vehicle with a gas at returning the vehicle. Thus, an example case where a gas station along the driving route is set to be a pick-up location of the print will be described.

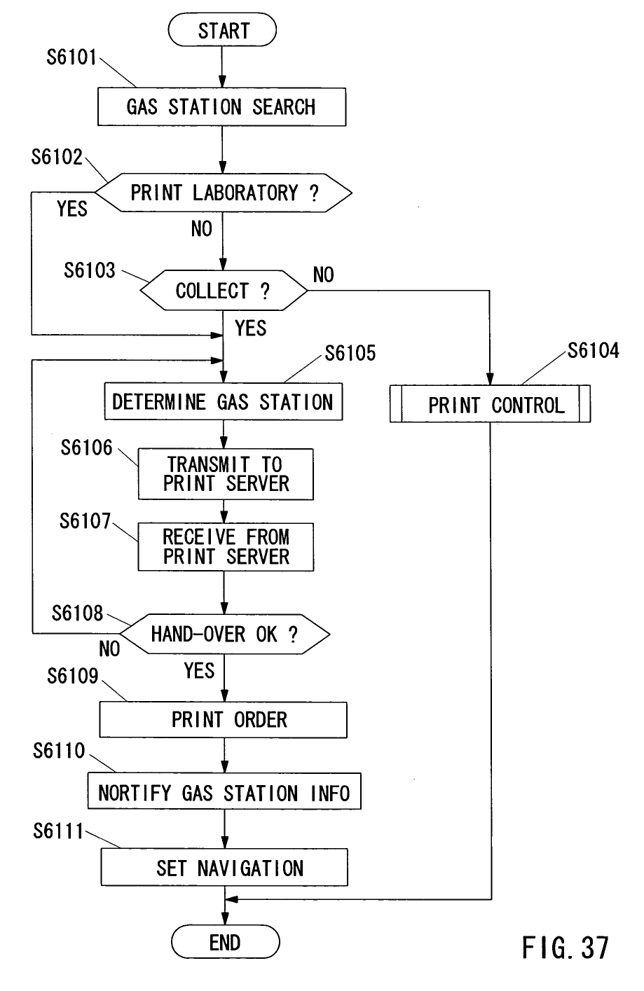

FIG. 37 is a flow chart showing a control to be executed in in-vehicle computer 201. This flow will be started detecting the print order. Instep S6101, a gas station along the driving route is searched for. A database about a gas station is provided in in-vehicle computer 201. The database also includes information about a business hour and a regular business day off, so the search is implemented taking into consideration a gas station incapable of handing over the print depending upon a day and a time. An external database about a gas station may be accessed.

In step S6102, it is judged whether or not there is a gas station having a print laboratory among gas stations hit by the search in step S6101. When there is the station, the station is selected as a taking order candidate and a flow proceeds to step S6105, but when there is not the station, a flow proceeds to step S6103. In step S6103, it is judged whether or not there is a gas station capable of collecting/delivering a print among the gas stations hit by the search in step S6101. When there is the station, the gas station is selected as a taking order candidate and a flow proceeds to step S6105, but when there is not the station, a flow proceeds to step S6104. In step S6104, a handing over location of a print like a convenience shop or so other than a gas station is searched for.

In step S6105, a gas station that hands over a print is decided. By prioritizing taking order candidates based upon various conditions, a gas station in higher rank is decided as a gas station for handing over from the candidates. The conditions referred to herein are geographic closeness to the return depot of the rental vehicle having an ample time to make a print and the like. In step S6106, an expected arrival time at the decided gas station and print order information are sent out to print server 301 where it is checked whether or not it is possible to hand over the print at the expected arrival time at the decided gas station. In step S6107, a checkout result is received from print server 301. In step S6108, it is judged whether or not it is possible to hand over based upon the checkout result received from print server 301. When it is possible to hand over, a flow proceeds to step S6109, but when it is not possible, a flow gets back to S6105 where a next gas station is decided from the candidates.

In step S6109, a print order is placed with print server 301. In step S6110, gas station information is displayed on monitor 107 and the gas station information is notified also by voice via speaker 109. In step S6111, navigation abilities automatically set the decided gas station as a sub destination. The sub destination is a navigation destination that is temporarily set. Even after a vehicle arrives at the sub destination, navigation still runs intact and will be continued until the vehicle arrives at the return depot of the rental vehicle that has been a main destination.

In print server 301 taking the print order, controls such as a print start, a print deliver and the like are executed with respect to a print laboratory like FIG. 36. With such the control, as a print can be handed over and also a gas refilling can be complete prior to returning the vehicle, the vehicle is not caused to be stopped over just for a print pick-up purpose. As the print is not picked up before the vehicle is returned, a user's home or a convenience shop close to the home may be selected as the print hand over location. A control of managing an image data stored in HDD 105 of in-vehicle computer 201 will be explained. If the image data stored in HDD 105 of in-vehicle computer 201 stays intact in HDD 105 thereof, a user cannot use the image data no more once the rental vehicle is returned and the image data might be viewed by another user renting the vehicle. In order to avoid such the inconvenience, a control of managing an image data to be executed in in-vehicle computer 201 will be explained.

In order that a user can use an image data stored in HDD 105 of in-vehicle computer 201 even after retuning a rental vehicle, in-vehicle computer 201 lets a user select a method that hands over the image data to the user. As the method to hand over the image data to the user, the method includes a method that moves an image data to an on-line accessible specified memory over the Internet and the like, a method that uploads an image data to an album server so as to be able to download the image data over the Internet afterward, a method that transmits an e-mail attaching with an image data and a method that stores an image data in a portable memory like CD-R and so. Once the control to hand over an image to the user is complete, automatically the image data is completely erased from HDD 105 of in-vehicle computer 201.

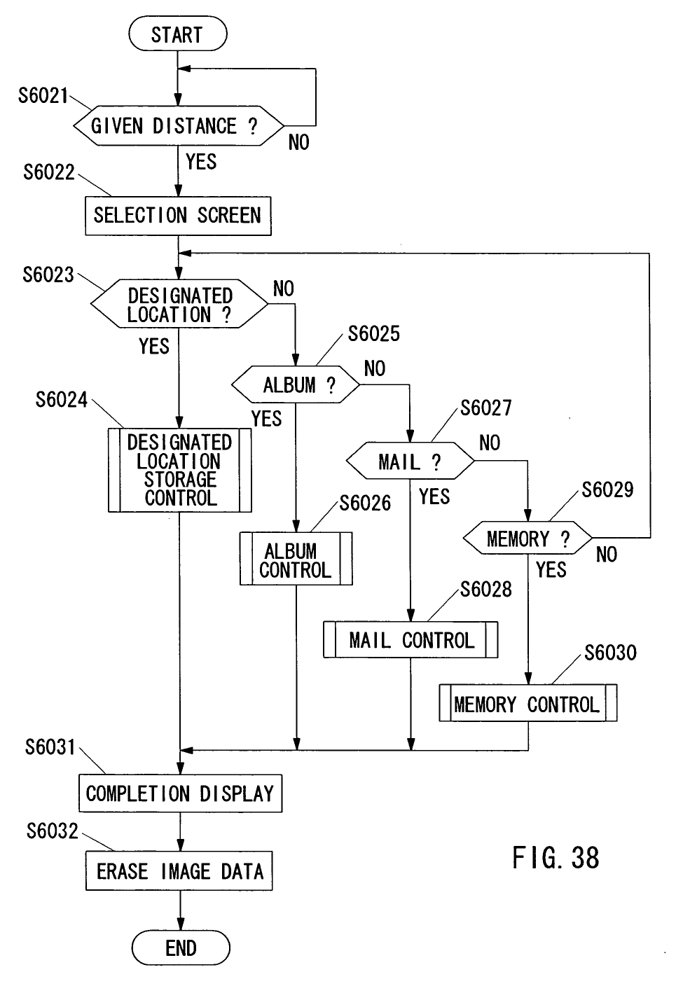

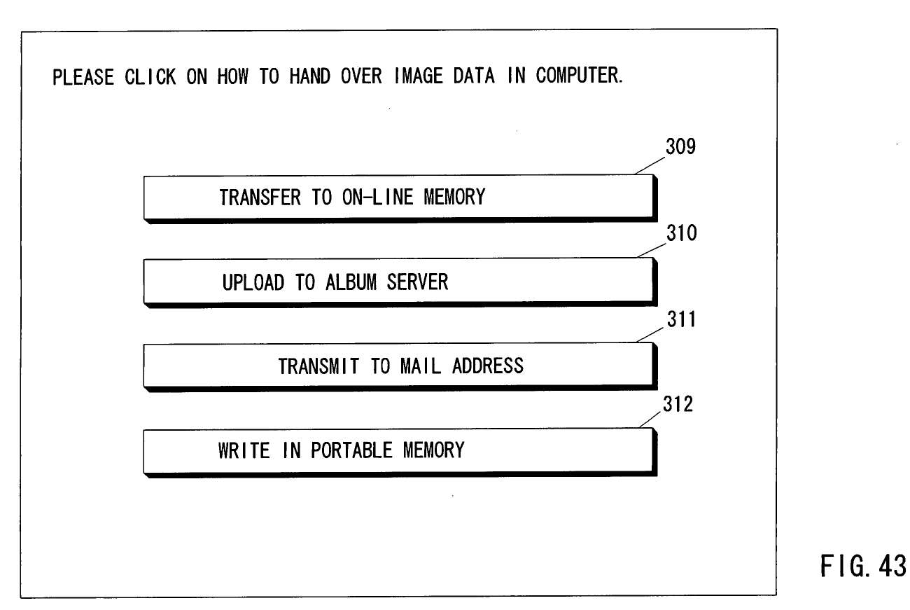

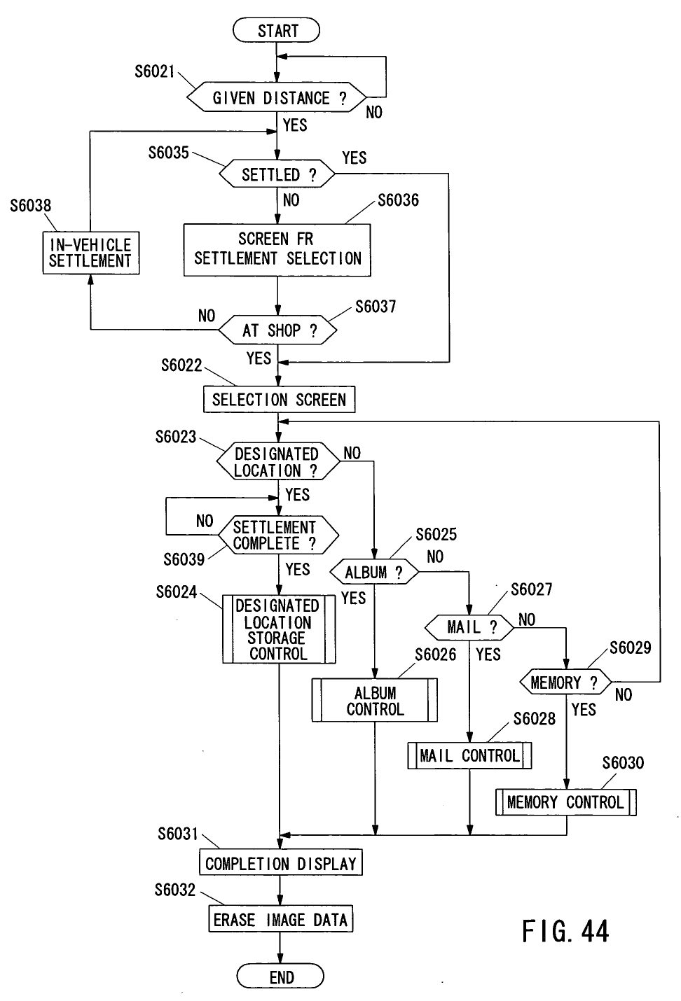

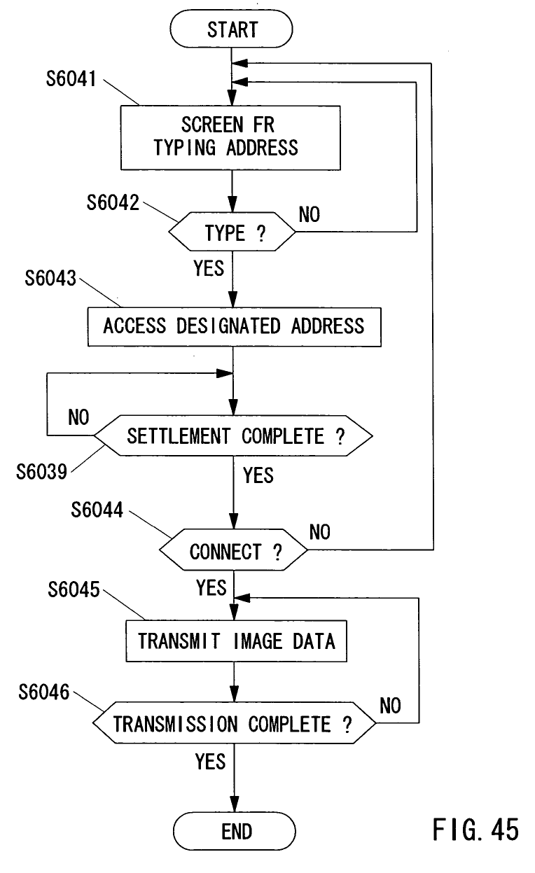

FIGS. 38 through 42 are flow charts showing an image management control to be executed in in-vehicle computer 201. In step S6021 of FIG. 38, it is judged whether or not a distance up to the return depot of the rental vehicle comes within a given distance using abilities of GPS sensor 111. The given distance herein is, for example, 2 Km. When the distance is within the given distance, a flow proceeds to step S6022, but when the distance is not within the given distance, judgment is continued. In step S6022, a screen to select a method for handing over an image data is displayed on monitor 107. FIG. 43 shows a display example of the method selection screen. In FIG. 43, when a user selects a method that transmits an image data to an on-line accessible specified memory using the Internet personally, click on button 309 and, when selecting a method that uploads an image data to an album server so as to be able to download the image data, click on button 310. Further, when selecting a method that transmits an e-mail attaching with an image data, click on button 311 and, when a method that stores an image in a portable memory like CD-R and so, click on button 312.

In step S6023, it is checked whether or not button 309 is clicked on. When button 309 is clicked, a flow proceeds to step S6024, but when button 309 is not clicked, a flow proceeds to step S6025. In step S6024, a control for storage of a designated location to be described hereinafter is executed. In step S6025, it is checked whether or not button 310 is clicked on. When button 310 is clicked, a flow proceeds to step S6026, but when button 310 is not clicked, a flow proceeds to step S6027. In step S6026, an album control to be described hereinafter is executed. In step S6027, it is checked whether or not button 311 is clicked on. When button 311 is clicked on, a flow proceeds to step S6028, but when button 311 is not clicked, a flow proceeds to step S6029. In step S6028, a mail control to be described hereinafter is executed. In step S6029, it is checked whether or not button 312 is clicked on. When button 312 is clicked on, a flow proceeds to step S6030, but when button 312 is not clicked, a flow gets back to step S6023. In step S6028, a memory control to be described hereinafter is executed.

In step S6031, completion of handing over the image data by the selected method is displayed on monitor 107. In step S6032, the image data stored in HDD 105 is completely erased. Erasing of an image data herein is a way of erasing in which a data erase program is used, so that the erased data is not undeleted.

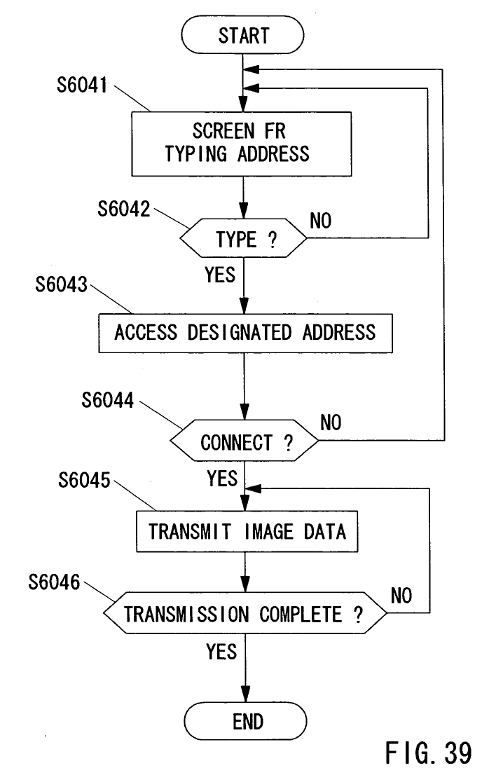

A control for storage of a designated location to be executed in step S6024 is explained. FIG. 39 is a flow chart showing a control for storage of a designated location to be executed in in-vehicle computer 201. In step S6041, a screen in which a user is prompted to type a designating memory address and a connection ID etc required to store an image data in an on-line memory is displayed on monitor 107. In step S6042, it is checked whether or not the address and the connection ID are typed. When the address and the connection ID are typed, a flow proceeds to step S6043, but when the address and the connection ID are not typed, a flow gets back to step S6041. In step S6043, an access to the designated address is tried.

In step S6044, it is checked whether or not the designated address is accessed. When the access is successful, a flow proceeds to step S6045, but when the access is failed, a flow gets back to step-S6041 where the correct address and connection ID are prompted to be typed once again. In step S6045, an image data stored in HDD 105 is transmitted to a memory of a connected designated address. In step S6046, it is checked whether or not transmission of all the image data is complete. When transmission thereof is complete, this flow is finished, but when transmission thereof is not finished, a flow gets back to step S6045 where transmission of the image data is continued.

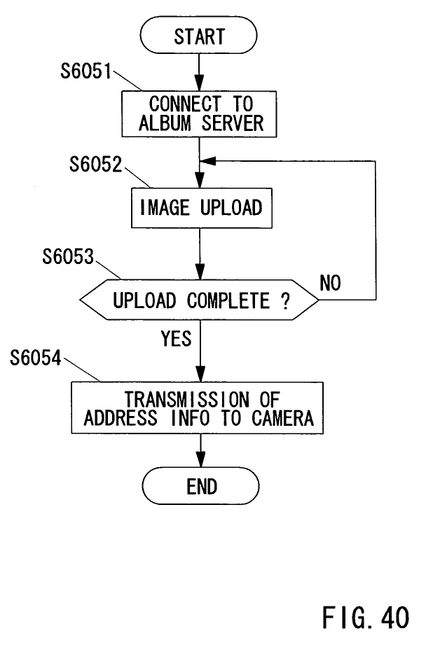

An album control to be executed in step S6026 will be explained. FIG. 40 is a flow chart showing an album control to be executed in in-vehicle computer 201. In step S6051, in-vehicle computer 201 is connected to a predetermined album server. In step S6052, an image data stored in HDD 105 is uploaded. In step s6053, it is checked whether or not uploading of the image data is complete. When uploading thereof is completed, a flow proceeds to step S6054, but when uploading thereof is not complete, a flow gets back to step S6052 where uploading thereof is continued. In step S6054, information such as an address, certificate ID and a password etc of the album server necessary to access the uploaded image data is caused to be stored in a memory of camera phone 101 and then this flow is finished.

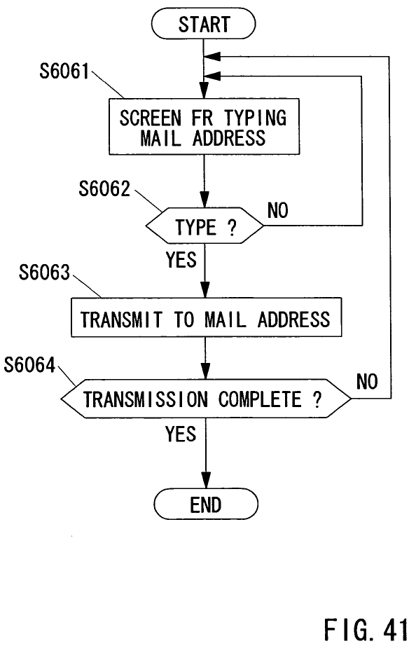

A mail control to be executed in step S6028 is explained. FIG. 41 is a flow chart showing a mail control to be executed in in-vehicle computer 201. In step S6061, a screen in which a user is prompted to type a mail address to transmit an image data is displayed on monitor 107. In step S6062, it is checked whether or not the mail address is typed. When the address is typed, a flow proceeds to step S6063, but when the address is not typed, a flow gets back to step S6061. In step s6043, a mail attaching with an image data stored in HDD 105 is transmitted to the typed mail address. In step S6064, it is checked whether or not transmission of the mail is complete. When transmission thereof is complete, this flow is finished, but when transmission thereof is not complete, as typing the mail address might be wrong, a flow gets back to step S6061 where the user is prompted to type a correct mail address again.

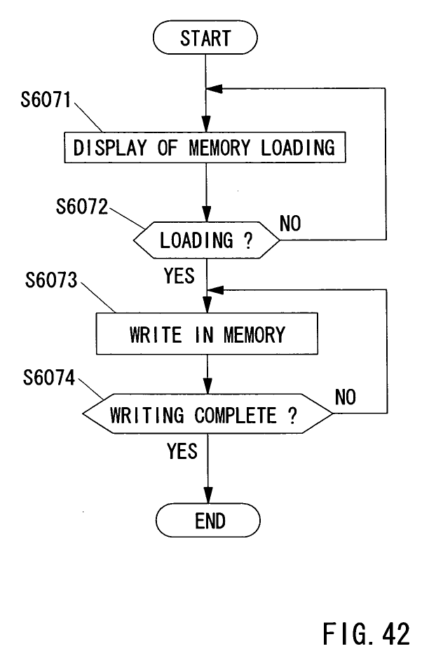

A memory control to be executed in step S6030 will be explained. FIG. 42 is a flow chart showing a memory control to be executed in in-vehicle computer 201. In step S6071, a screen where to prompt to install a portable memory to write an image data is displayed on monitor 105. It is checked whether or not a memory is installed. When the memory is installed, a flow proceeds to step S6073, but when the memory is not installed, a flow gets back to step S6071.

In step S6073, an image data in HDD 105 is written into the installed memory. In step S6074, it is checked whether or not writing of the image data into the memory is complete. When writing thereof is complete, this flow is finished, but when writing thereof is not complete, a flow gets back to step S6073 where writing of the image data into the memory is continued.

Such the control that an image data in HDD 105 of in-vehicle computer 201 is handed over to a user enables the user to easily obtain the image data. And the image data can be prevented from being viewed by a user who will rent the vehicle. In such the control, as an address, a certificate ID and a password necessary to access an album page are caused to be stored into camera phone 101, the address and the like with respect to the album page cannot be forgotten without taking a trouble to leave a hand-written memo or so.

Prior to executing of a control to hand over an image data to a user, a settlement of any of a rental vehicle charge or a print charge or a combined settlement of both charges is checked and the control may then be executed after confirming completion of the settlement. FIGS. 44 and 45 are flow charts showing an image management control to be executed in in-vehicle 201. FIG. 44 in which steps S6035 through S6039 are added into FIG. 38 is the same as FIG. 38 rather than steps S6035 through S6039. Thus, steps S6035 to S6039 will be mainly explained.

In step s6021, when it is judged that a vehicle positioning is within a given distance, a flow proceeds to step S6035 where it is checked whether a settlement of any of a rental vehicle charge or a print charge or a combined settlement of both charges is complete. Settlement completion is confirmed by, for example, what a process of step S5010 in FIG. 33 was normally completed. When a charge settlement is complete, a flow proceeds to step S6022, but when the settlement is not complete, a flow proceeds to step S6036 where to display a screen for causing a user to select a settlement way. As the settlement way, a user is caused to select any of an in-vehicle settlement like a settlement using the settlement system employed in a cell phone as described in step S5010 of FIG. 35 or an in-store settlement in which the settlement is made at the return depot of a rental vehicle. When the in-vehicle settlement is clicked on, a flow proceeds to step S6038 where a settlement is made using the settlement system of a cell phone and gets back to step S6035. When the in-store settlement is clicked on, a flow proceeds to step S6022. Then, in steps S6023, S6025, S6027 and S6029 where a method to hand over an image data to a user is checked respectively, a flow proceeds to step S6039. Step S6039 is interposed between steps S6023 and S6024, steps S6025 and S6026, steps S6027 and S6028 and steps S6029 and S6030 respectively, but as a process of step S6039 is the same therein and is not a process that does not affect a subsequent process, FIG. 44 just shows a flow between steps S6023 and S6024 only. In step S6039 where an input of a signal indicative of a completion of a settlement is put on standby, a flow proceeds to steps S6024, S6026, S6028 and S6030 when the signal is input. The signal indicative of a completion of a settlement is transmitted to in-vehicle computer 201 when a cash registering system in a store implements a book recording process. Or a staff member of a shop having implemented the book recording implements a certain input operation to in-vehicle computer 201.

The process of step S6039 may be performed in the middle of the process of step S6024, step S6026, step S6028 or step S6030. FIG. 45 is a flow chart showing a case where the process of step S6029 is performed in the middle of the process of step S6024, wherein after typing of necessary information is finished, namely, step S6039 is added following step S6042 of FIG. 39. This step flow is true of a case where the process of step S6039 is performed in the middle of the process of step S6026, step S6028 or step S6030. Accordingly, an input to settle a charge and an input to obtain an image data can be performed collectively. Like this, an image data is handed over to a user after confirming completion of a settlement of any of a rental vehicle charge or a print charge or a combined settlement of both charges, so there is no error of collecting a charge.

Like the foregoing, in the second embodiment, the camera system working with camera phone 101 in use by a user and a rental vehicle has been explained, but along with renting of a vehicle, camera phone 101 may be rented. This invention can be realized using a private vehicle and a business vehicle on top of a rental vehicle. An example using a vehicle as a rental vehicle has been described, but a small airplane and a motorcycle etc can realize this invention too without a so-called vehicle.

What is claimed is:

1. A vehicle driving management system comprising:
an order taking device that takes a print order of an image data;
a stopover information obtaining device that obtains stopover information including a vehicle's stopover depot or stopover time;
a printer that prints an image data; and
a control device that controls so as to be able to hand over merchandise printed by the printer at a stopover depot or a stopover time obtained by the stopover information obtaining device.

2. A rental vehicle system comprising:
an order taking device that takes a print order of an image data;
a return depot obtaining device that obtains a return depot of a rental vehicle;
a printer that prints an image data; and
a control device that controls so as to be able to hand over merchandise printed by the printer at a return depot obtained by the return depot obtaining device.

3. The rental vehicle system according to claim 2, wherein the control device is provided with an arrangement device that arranges delivery.

4. The rental vehicle system according to claim 2, wherein the control device instructs a printer provided at the return depot to make a print.

5. A rental vehicle system comprising:
an order taking device that takes a print order of an image;
a return time obtaining device that obtains a return time of a rental vehicle;
a printer that prints an image data; and
a control device that controls so as to be able to hand over merchandise printed by the printer at a return time obtained by the return time obtaining device.

6. The rental vehicle system according to claim 5, wherein the control device controls a print start time of the printer.

7. A vehicle driving management system comprising:
a communication device that communicates with an external computer;
an ordering device that places a print order of an image data with the external computer via the communication device;
a stopover information obtaining device that obtains stopover information including a vehicle's stopover depot or stopover time;
a detection device that detects a present positioning or a present time of the vehicle; and
a control device that controls so as to prompt a last print order via the ordering device before the vehicle arrives at the stopover depot or the stopover time comes based upon the present positioning or the present time detected by the detection device.

8. A rental vehicle system comprising:
a communication device that communicates with an external computer;
an ordering device that places a print order of an image data with the external computer via the communication device; and
a control device that controls so as to prompt a last print order via the ordering device prior to returning of a rental vehicle.

9. The rental vehicle system according to claim 8 further comprising a detection device that detects whether the rental vehicle comes within a given distance inclusive of a return depot, wherein the control device prompts to place the final print order based upon a detection result of the detection device.

10. A rental vehicle system comprising:
an ordering device that places a print order of an image data;
a settlement instruction device that instructs to settle a print charge ordered by the ordering device; and
a control device that controls so as to instruct a settlement of a print charge by the settlement instruction device prior to returning of a rental vehicle.

11. The rental vehicle system according to claim 10, wherein the control device controls so as to instruct a settlement of a rental vehicle charge along with a settlement of the print charge.

12. A rental vehicle system comprising:
a memory that is provided in a vehicle and stores an image data received from a digital camera;
a backup device that backs up so as to be able to view an image data in the memory even after the rental vehicle is returned; and
a control device that controls so as to back up an image data in the memory before a rental vehicle is returned.

13. The rental vehicle system according to claim 12 further comprising a communication device that communicates with an external computer, wherein the backup device transmits an image data to the external computer via the communication device.

14. The rental vehicle system according to claim 12 further comprising a storage device that stores a data in a portable memory, wherein the backup device stores an image data of the memory in a portable memory.

15. The rental vehicle system according to claim 12, wherein the control device prompts a user to back up an image data in the memory.

16. The rental vehicle system according to claim 12 further comprising a detection device that detects whether a rental vehicle comes within a given distance inclusive of a return depot, wherein the control device controls so as to back up an image data based upon a detection result of the detection device.

17. The rental vehicle system according to claim 12, wherein the control device controls so as to be able to back up by the backup device corresponding to settlement completion of a rental vehicle charge or a rental vehicle charge and a print charge.

18. A rental vehicle system comprising:
a memory that is provided in a rental vehicle and stores an image data received from a digital camera;
an erasing device that erases an image data in the memory; and
a control device that controls the erasing device so as to erase an image data in the memory automatically prior to returning of the rental vehicle.

19. The rental vehicle system according to claim 18 further comprising a detection device that detects whether a rental vehicle comes within a given distance inclusive of a return depot, wherein the control device controls so as to erase an image data automatically corresponding to a detection result of the detection device.

20. A camera system comprising:
an in-vehicle computer that is installed in a vehicle and executes a given function;
a digital camera that takes a photograph of a subject;
a connecting device that connects the in-vehicle computer and the digital camera;
a communication device that enables a data to be sent/received between the in-vehicle computer and an external computer;
an instructing device that instructs to transmit to the external computer an image data taken with the digital camera via the communication device;
a judging device that judges whether there is data to be sent/received in order to realize the given function being executed by the in-vehicle computer; and
a control device that controls so as to transmit data to be sent/received by the given function in preference to transmission of an image data by the instructing device based upon judgment of the judging device.

21. The camera system according to claim 20, wherein the given function is car navigation abilities.

22. The camera system according to claim 20, wherein the control device sends/receives data necessary to realize the given function prior to starting transmission of the image data to the external computer.

23. The camera system according to claim 20, wherein the judging device executes judgment while the image data is in transit and the control device suspends transmission of the image data when it is judged that there is data to be sent/received by the given function while the image data is in transit.

24. The camera system according to claim 20, wherein the external computer is a print server computer and the image data is transmitted in order to make a print.

25. The camera system according to claim 20, wherein the external computer is an image processing computer that is provided with image processing abilities and the image data is transmitted in order to perform an image processing on.

26. The camera system according to claim 25, wherein the image data is a RAW image data and the image processing is a pixel interpolation processing.

27. The camera system according to claim 25, wherein the communication device transmits information about the digital camera along with an image data and the image processing is a processing that optimizes an image based upon information about the digital camera.

28. The camera system according to claim 22, wherein the connecting device is a cradle in which the digital camera is arranged.

29. A camera system comprising:
an in-vehicle computer that is installed in a vehicle;
a digital camera that takes a photograph of a subject;
a connecting device that connects the in-vehicle computer and the digital camera;
a communication device that enables data to be sent/received between the in-vehicle computer and an external computer;
an instructing device that instructs so as to transmit to the external computer an image data taken with the digital camera via the communication device; and
a control device that controls so as to put the image data on standby for transmission until the communication device becomes communicable with the external computer in a case where the communication device cannot communicate with the external computer when transmission of an image data is instructed by the instructing device.

30. The camera system according to claim 29, wherein the control device starts transmission of an image data on standby for transmission automatically when the communication device becomes communicable with an external computer.

31. A camera system comprising:
an in-vehicle computer that is installed in a vehicle;
a first communication device;
a digital camera that takes a photograph of a subject;
a connecting device that connects the in-vehicle computer and the digital camera;
a second communication device that enables data to be sent/received between the in-vehicle computer and the external computer; and
an instructing device that instructs so as to transmit to the external computer an image data taken with the digital camera via the communication device, wherein the in-vehicle computer with connection to the digital camera by the connecting device enables data to be sent/received between the in-vehicle computer and the external computer via the first communication device and the instructing device uses the second communication device in preference to the first communication device.

32. The camera system according to claim 31, wherein the in-vehicle computer is provided with an image processing device that image-processes an image data and, when the second communication device is communicable, transmits an image data using the second communication device, not performing the image processing on an image data.

33. The camera system according to claim 32, wherein, when the first communication device is communicable whereas the second communication device is not communicable, an image data is performed by the image processing and is transmitted using the first communication device.

34. The camera system according to claim 32, wherein, the image data is a RAW image data and the image processing is any of a pixel interpolation processing, an image optimizing processing or an image compression processing.

35. An in-vehicle computer comprising:
a navigation apparatus that realizes car navigation abilities;
a display monitor that performs a navigation display of the car navigation abilities;
an obtaining device that obtains transmittable area information on a wireless communication; and
a control device that controls so as to display a transmittable area on a navigation display of the display monitor based upon the obtained transmittable area information.

36. The in-vehicle computer according to claim 35 further comprising a communication device that communicates with an external computer and a memory that stores data to be transmitted via the communication device, wherein, when data to be transmitted is stored in the memory, a transmittable area is automatically displayed on a navigation display.

37. The in-vehicle computer according to claim 35, wherein the navigation apparatus calculates a driving route of car navigation using the transmittable area information.

38. The in-vehicle computer according to claim 37 further comprising a communication device that communicates with an external computer and a memory that stores data to be transmitted via the communication device, wherein, when data to be transmitted is stored in the memory, the navigation apparatus calculates a driving route of car navigation using the transmittable area information.

39. An in-vehicle computer system comprising:
an in-vehicle computer that is installed in a vehicle;
a portable terminal that stores data;
a connecting device that connects the in-vehicle computer and the portable terminal;
a communication device that enables data to be sent/received between the in-vehicle computer and an external computer;
an instructing device that instructs so as to transmit to the external computer an image data in the portable terminal via the communication device;
a judging device that judges whether there is data to be sent/received in order to realize other function being executed by the in-vehicle computer; and
a control device that controls so as to transmit data to be sent/received by the other function in preference to transmission of data in the portable terminal by the instructing device.

40. An in-vehicle computer system comprising:
an in-vehicle computer that is installed in a vehicle;
a portable terminal that stores data;
a connecting device that connects the in-vehicle computer and the portable terminal;
a communication device that enables data to be sent/received between the in-vehicle computer and an external computer;
an instructing device that instructs so as to transmit to the external computer an image data in the portable terminal via the communication device; and
a control device that controls so as to put data in the portable terminal on standby for transmission until the communication device becomes communicable with the external computer in a case where the communication device cannot communicate with the external computer when transmission of at a in the portable terminal is instructed by the instructing device.

41. An in-vehicle computer system comprising:
a navigating device that navigates a driving route;
a driving route setting device that sets a driving route destined for a destination; and
a print control device that controls so as to perform a print processing on an image data by a given printer corresponding to the driving route set by the driving route setting device.

42. The in-vehicle computer system according to claim 41, wherein the print control device controls so as to perform a print processing by a printer at a print laboratory located along just about a driving route.

43. The in-vehicle computer system according to claim 41, wherein the print control device controls so as to enable a print to be picked up at a hand-over station along just about a driving route.

44. The in-vehicle computer system according to claim 41 further comprising a communication device that communicates with an external computer, wherein the print control device instructs to the external computer a print processing.

45. The in-vehicle computer system according to claim 41 further comprising a communication device that communicates with an external computer, wherein the print control device controls so as to receive information on a print from the external computer via the communication device.

46. The in-vehicle computer system according to claim 45, wherein the print control device receives print laboratory information from the external computer via the communication device.

47. The in-vehicle computer system according to claim 45, wherein the print control device receives print hand-over station information from the external computer via the communication device.

48. The in-vehicle computer system according to claim 45, wherein the print control device transmits geographic positioning information to the external computer and receives information on a print.

49. The in-vehicle computer system according to claim 43, wherein the hand-over station is a gas station.

50. The in-vehicle computer system according to claim 41, wherein the in-vehicle computer is installed in a rental vehicle.

51. The in-vehicle computer system according to claim 50, wherein the print control device controls so as to be able to pick up at a hand-over station closer to the return depot of a rental vehicle.

52. A camera system comprising:
a digital camera that takes a photograph of a subject and captures an image data;
a plurality of image processing computers that receive an image data taken with the digital camera and perform an image processing with respect to the received image data; and
a certificate computer that certificates a user transmitting an image data to be received by the image processing computer, wherein the certificate computer is provided with a selecting device that selects an image processing computer performing an image processing on an image data taken with the digital camera.

53. The camera system according to claim 52, wherein, when certification of the user is succeeded, the certificate computer permits the user to access the image processing computer.

54. The camera system according to claim 52, wherein, when certification of the user is succeeded, the certificate computer transmits connection address information on the image processing computer to the user.

55. The camera system according to claim 52, wherein the certificate computer does not receive an image data taken with the digital camera.

56. The camera system according to claim 52 further comprising an in-vehicle computer having a communication device that transmits an image data taken with the digital camera to an external computer, wherein the in-vehicle computer transmits the image data to the image processing computer.

57. The camera system according to claim 52 further comprising communication abilities, wherein the certificate computer is provided with a receiving device that receives certificate information from the digital camera, a certificating device that certificates the user based upon certificate information received by the receiving device and a transmitting device that transmits to the digital camera a connection address in order to access the image processing computer when certification is succeeded by the certificating device.

58. The camera system according to claim 52, wherein the image processing computer is a computer that instructs a printer to print an image data.

59. The camera system according to claim 52, wherein the image processing computer is a plurality of computers executing a print processing that are provided at a print laboratory.

60. The camera system according to claim 52, wherein the digital camera transmits to the image processing computer a taken image data in a RAW image data and the image processing computer executes an image processing that imagines the RAW image data.

61. The camera system according to claim 52, wherein the digital camera transmits to the image processing computer information on a camera and the image processing computer executes an image processing that optimizes an image data taken with the digital camera based upon information on the digital camera.

62. A camera system comprising:
a digital camera that takes a photograph of a subject by an operation of a user;
a plurality of image processing computers that receive an image data taken with the digital camera and perform an image processing with respect to a received image data; and
an image storage computer that stores an image data processed by the image processing with a plurality of image processing computers in an integrated way.

63. A camera system comprising:
a digital camera that takes a photograph of a subject via a taking lens; and
a plurality of image processing computers that receive a RAW image data taken with the digital camera and information on a camera and perform an image processing with respect to a received image data, wherein the image processing computer is provided with an image optimizing device that performs an optimizing process of eliminating an affect caused by the taking lens with respect to the RAW image data.

64. The camera system according to claim 63, wherein the information on a camera is information on a product model of the digital camera, the image processing computer stores taking-lens information with linkage to the product model information in advance and the image optimizing device performs the image optimizing process based upon the taking-lens information.

65. A camera system comprising:
a digital camera that takes a photograph of a subject and obtains an image data thereof; and
a plurality of image processing computers that receive an image data taken with the digital camera and perform an image processing with respect to a received image data, wherein the image processing computer is provided with an updating device that updates an image processing program by accessing a computer storing the latest image processing program automatically prior to executing of the image processing.

66. A camera system comprising:
a digital camera that obtains an image data thereof taking a photograph of a subject;
a plurality of image processing computers that receive an image data taken with the digital camera and information on a camera and perform an image processing with respect to a received image data; and
a computer terminal that performs an optimizing process on an image data taken with the digital camera, wherein, when the image processing computer receives an image data processed by the computer terminal, the image processing computer judges how an optimizing process was performed on an image data and performs an optimizing process alone that was not performed by the computer terminal.

67. A camera system comprising:
an in-vehicle computer that is installed inside a vehicle;
a digital camera that is provided with cell phone abilities;
a microphone that inputs a voice; and
a speaker that outputs a voice, wherein the in-vehicle computer with connection to the digital camera extracts an image data stored in the digital camera and makes it possible to call with the use of the microphone and the speaker.

68. The camera system according to claim 67 further comprising a monitor that displays a moving image, wherein the in-vehicle computer makes it possible to perform a TV phone with the use of the monitor, the microphone and the speaker.

69. The camera system according to claim 67, wherein the in-vehicle computer is provided with car navigation abilities and the monitor is a monitor that displays a navigation screen.

70. The camera system according to claim 67, wherein the camera system is connected to the in-vehicle computer and is provided with a cradle in which the digital camera is arranged and the in-vehicle computer and the digital camera are connected by the cradle.

71. A camera system comprising:
an in-vehicle computer that is installed inside a vehicle;
a digital camera that is provided with cell phone abilities;
a microphone that inputs a voice; and
a speaker that outputs a voice, wherein the in-vehicle computer with connection to the digital camera recharges a battery of the digital camera and makes it possible to call with the use of the microphone and the speaker.

72. A camera system comprising:
an in-vehicle computer that is installed inside a vehicle and provided with car navigation abilities;
a digital camera that is provided with communication abilities; and
a connecting device that connects the in-vehicle computer and the digital camera, wherein the in-vehicle computer with connection to the digital camera can send/receive data necessary for car navigation using communication abilities of the digital camera.

73. A camera system comprising:
a car navigating device that executes car. navigation abilities;
a monitor that displays a car navigation screen;
an extracting device that extracts an image data in a digital camera; and
a control device that controls so as to display a screen to instruct a print order of an extracted image data on the monitor after an image data was extracted by the extracting device.

74. A camera system comprising:
an in-vehicle computer that is installed inside a vehicle;
an extracting device that extracts an image data in a digital camera;
an instructing device that instructs an extraction of an image data with the extracting device; and
a control device that controls so as to stand by an extracting process of an image data in a case where the extracting process of the image data is instructed when a given function is being executed by the in-vehicle computer.

75. The camera system according to claim 74 further comprising a judging device that judges whether or not an extracting process of an image data affects an execution of the given function and a control device that controls so as to halt an extracting process of an image data according to a judgment of the judging device.

76. A camera system comprising:
an in-vehicle computer that is installed inside a vehicle;
an extracting device that extracts an image data in a digital camera; and
a control device that controls so as to suspend the extracting process of an image data in a case where a given function is executed by the in-vehicle computer while an image data is being extracted by the extracting device.

77. The camera system according to claim 76 further comprising a judging device that judges whether or not an extracting process of an image data affects an execution of the given function and a control device that controls so as to halt an extracting process of an image data according to a judgment of the judging device.

78. An in-vehicle computer comprising:
a connecting device that connects to a digital camera;
an extracting device that extracts an image data from the digital camera; and
an image processing device that automatically performs an image processing with respect to an image data extracted from the digital camera.

79. The in-vehicle computer according to claim 78, wherein the extracting device extracts information on the taking digital camera along with an image data and the image processing device optimizes an image data according to the information.

80. The in-vehicle computer according to claim 78, wherein an image data extracted from the digital camera includes a RAW image data and the image processing device performs a pixel interpolation or an image compression with respect to the RAW image data.

81. The in-vehicle computer according to claim 78 further comprising a communication device that communicates with an external computer, wherein the communication device transmits to the external computer an image data processed by the image processing device.

82. An in-vehicle computer comprising:
a connecting device that connects to a digital camera;
an extracting device that extracts an image data from the digital camera via the connecting device;
a judging device that judges whether or not a given condition is met; and
a control device that controls so as to execute a first process about an image data when it is judged by the judging device that the given condition is met and, when it is judged by the judging device that the given condition is not met, execute a second process about an image data.

83. The in-vehicle computer according to claim 82 further comprising a monitor that displays a moving image, wherein the first process displays the extracted image data on the monitor and the second process prohibits the extracted image data from being displayed on the monitor.

84. The in-vehicle computer according to claim 83, wherein the control device receives a print order of an image data via the first process.

85. The in-vehicle computer according to claim 82 further comprising a detection device that detects a passenger, wherein the judging device judges whether or not there is a passenger by the detection device.

86. A digital camera comprising:
a communication device that transmits a taken image data to an external apparatus; and
a deleting device that can delete an image data taken at a last time by a specific operation during a certain period of time after an image data was taken, wherein transmission of an image data by the communication device is put on standby during a certain period of time when an image data can be deleted by the deleting device and after the certain period of time has elapsed, the image data is transmitted to an external apparatus.

87. The digital camera according to claim 86 further comprising a displaying device, wherein the image data taken at a last time is displayed on the displaying device during the certain period of time.

88. The digital camera according to claim 87, wherein the displaying device implements a display of prompting a delete operation along with the image data taken at a last time during the certain period of time.

89. The digital camera according to claim 86, wherein an image data to be transmitted to an external apparatus by the communication device is a RAW image data.

90. An image processing apparatus comprising:
a communication device that transmits a taken image data to an external apparatus;
an image processing device that performs an optimizing process with respect to the image data;
an instructing device that instructs an image data to be transmitted to the external apparatus with use of the communication device; and
a control device that controls so as to perform an optimizing process by the image processing apparatus with respect to an image data instructed to be transmitted to the external apparatus by the instructing device.

91. The image processing apparatus according to claim 90, wherein the instructing device instructs an image data on print order.

92. The image processing apparatus according to claim 90 further comprising an obtaining device that obtains information on a taking camera, wherein the image processing performs an optimizing process with respect to an image data according to the information on a taking camera.

93. The image processing apparatus according to claim 90, wherein the image data is a RAW image data.

94. An image processing apparatus comprising:
a communication device that transmits a taken image data to an external apparatus;
an image processing device that performs an optimizing process with respect to the image data;
an instructing device that instructs an image data to be transmitted to the external apparatus with use of the instruction device; and
a control device that controls so as to perform an optimizing process with respect to an image data excluding an image data instructed to be transmitted to the external apparatus by the image processing device.

95. The image processing apparatus according to claim 94, wherein the external apparatus is provided with a second image processing device that performs an optimizing process with respect to an image data.

96. An image processing apparatus comprising:
a receiving device that receives an image data from a digital camera;
an image processing device that performs an optimizing process with respect to an image data received by the receiving device; and
a sending device that automatically transmits to the digital camera an image data performed by an optimizing process with the image processing device.

97. The image processing apparatus according to claim 96 further comprising an obtaining device that obtains information on a taking camera, wherein the optimizing process performs an optimizing process with respect to an image data according to the information on a taking camera.

98. The image processing apparatus according to claim 96, wherein the image data is a RAW image data.

99. The image processing apparatus according to claim 96 further comprising an identifying device that identifies a file format of a received image data, wherein, when the identifying device detects a RAW image data, an optimizing process is performed after processing of a pixel interpolation.
